(19) United States
(12) Patent Application Publication
(10) Pub. No.: US 2025/0187225 A1
(43) Pub. Date: Jun. 12, 2025

(54) PANEL SAW HAVING A SAFETY DEVICE FOR PREVENTING CUTTING INJURIES

(71) Applicant: ALTENDORF GMBH, Minden (DE)

(72) Inventors: ANDREAS NEUFELD, Porta-Westfalica (DE); Karl-Friedrich Schröder, Alt-Espelkamp (DE); Julia Pohle, Minden (DE)

(21) Appl. No.: 18/272,693

(22) PCT Filed: Jan. 11, 2022
(86) PCT No.: PCT/EP2022/050418

§ 371 Date: Jul. 17, 2023

(30) Foreign Application Priority Data
Jan. 19, 2021 (DE) 20 2021 100 243.3

(51) Int. Cl. B27G 19/00; B27B 5/06; B27B 5/38; B27G 19/02

(52) U.S. Cl. CPC B27G 19/008; B27B 5/38; B27G 19/022; B27G 19/025; B27B 5/06

(57) ABSTRACT

A circular saw includes a support surface for a workpiece and which has a saw blade slot, a main drive motor arranged below the support surface for driving a saw blade in rotational movement, and a saw blade holder connected to the main drive motor for the purpose of transmitting the rotational movement A height-adjustment apparatus, with a height actuator and a transmission element coupled to the saw blade holder are arranged to set the spacing between a saw blade holder and the support surface An electronic interface provides the input of a saw blade projection. A protection apparatus is connected by signals to a monitoring apparatus and the height actuator and is adapted to activate the height actuator for quick lowering of the saw blade holder when a dangerous situation is recorded by the monitoring apparatus.

### CROSS-REFERENCE TO FOREIGN PRIORITY APPLICATION

The present application claims the benefit under 35 U.S.C. §§ 119(b), 119(e), 120, and/or 365(c) of PCT/EP2022/050418 filed Jan. 11, 2022, which claims priority to German Application No. DE 20 2021 100 243.3 filed Jan. 19, 2021.

### FIELD OF THE INVENTION

The invention relates to a circular saw comprising: a support surface for a workpiece and which has a saw blade slot, a main drive motor arranged below the support surface for driving a saw blade in rotational movement, a saw blade holder connected to the main drive motor for the purpose of transmitting the rotational movement and comprising a saw blade bearing unit and a saw blade flange which is mounted so that it can be rotated about a saw blade axis by means of the saw blade bearing unit and is designed to be connected to the saw blade so that it is fixed in torsion, a height-adjustment apparatus, with a height actuator and a transmission element coupled to the saw blade holder, which is arranged and designed to set the spacing between the saw blade holder and the support surface, an electronic interface for the input of a saw blade projection, a control device which is connected by signals to the electronic interface and to the height actuator and is designed to activate the height actuator such that a saw blade projection input via the user interface is set by means of the height actuator, and a protection apparatus for quickly lowering the saw blade in a dangerous situation having a monitoring apparatus for recording a dangerous situation.

### BACKGROUND OF THE INVENTION

Circular saws are machine tools for making straight cuts on boards, profiles, bars, or planks. Circular saws can be configured as relatively small home improvement circular saws for the occasional amateur user, as manageable circular saws for mobile use on construction sites, or as panel saws for professional use in carpentry workshops or in similar professional applications.

Panel saws are professional machine tools which are used in carpentry workshops and other industrial or artisan workshops in order to cut to size wood or materials with similar physical properties to wood, plastics, minerals, and light metals. A panel saw is here typically characterized by a support surface on which the workpiece is supported and a saw blade projecting from this support surface through a slot and which rotates about a saw blade axis which is situated below the support surface in order to make the saw cut. The workpiece can be pushed relative to the saw blade axis in order to carry out the saw cut. In order to do this, in the case of the typical panel saw used in artisan workshops, the workpiece can be moved using a small amount of force on the support surface, in particular a sliding part of the support surface and the axis of the saw blade is stationary when the saw cut is made. The operator here stands to the side of the saw blade, unlike the position of the operators of table saws who operate it from front on and therefore can also grip and push the workpiece on both sides of the saw blade.

An alternative embodiment of a panel saw makes the saw cut by the workpiece being fixed on the support surface so that it is stationary and the saw blade being arranged on a saw unit which can be displaced in translation such that in this case the saw blade is set in translational movement in order to carry out the saw cut. A panel saw is generally already known from EP 2 527 069 A1, DE 20 2009 007 150 U1, or WO 2012/159956 A1.

Panel saws are characterized by a high cut quality and cutting accuracy and can carry out saw cuts at a high capacity. This means that solid wood and very thick workpieces can also be cut to size by panel saws. For this purpose, panel saws can be equipped with saw blades of a different diameter and the diameters here range from 10 to 15 cm up to very large circular saw blades with a diameter of, for example, 55 cm.

Although numerous conventional safety precautions have been provided on panel saws for a long time, such as for example a guard which is placed over the saw blade from above and can also serve to extract sawdust, or a push stick with which small workpieces can be pushed in proximity to the saw blade and, although panel saws are often used by skilled operators with specific training in using the machines, cutting injuries to operators on the saw blade of a panel saw frequently occur. Such injuries typically take the form of the partial or complete severing of parts of fingers, fingers, or even hands.

The inventors have discovered that the causes of such injuries reside in various operating procedures which are carried out in error or by accident. A common cause is the careless removal of cut-off pieces from the region around the saw blade when quick hand movements are often made around the saw blade and contact with the saw blade, causing an injury, takes place as a result. Other causes are a hand slipping off the workpiece when the workpiece is being pushed forward, or careless movements by the user, for example tripping, working under time pressure, or poor coordination when more than one operator is working on a panel saw.

In order to prevent such injuries, active protection apparatuses have also been proposed at various times instead of the customary passive safety devices. A system from the American manufacturer “SawStop®”, in which, based on a difference between the conductivity and the capacitive behavior of wood and a body part at the saw blade, contact between the saw blade and a body part should be used as a differentiating detection compared with contact of the saw blade with the workpiece as a trigger, was first proposed in 1999. As soon as such a contact of a body part has been identified, quick braking of the saw blade starts, the purpose of which is to bring the saw blade to a standstill as quickly as possible in order thereby to prevent a serious injury. The system has shown itself to be capable of avoiding serious injuries in certain use situations. A disadvantage of the system, however, was that the quick braking generally entailed irreparable damage to the saw blade and, due to the detection system, is unable to avoid serious injury in certain types of accident, in particular when the body part approaches the saw blade quickly. This protective system is described, for example, in EP 1 234 285 B1, WO 2017/210091 A1, and US 2014/0331833 A1.

The inventors have discovered that the protection apparatus encounters physical limitations when injury is to be prevented solely by braking of the saw blade. Firstly, this is because the kinetic energy which is stored in the quickly rotating saw blade requires a considerable braking power which, in order to avoid certain circumstances of accidents, cannot be exerted without damaging the saw blade. This is true in particular when larger saw blades are used which, by virtue of their high moment of inertia, store too much energy for braking that is gentle on the saw blade. The inventors have thus discovered that, for typical use cases on a panel saw, the braking power to brake a saw blade with a diameter of 550 mm and with a braking time of 10 ms is approximately 1500 kW, whereas in the case of a saw blade diameter of 250 mm it is only about 300 kW even though this small saw blade is being driven at approximately twice the speed of the larger saw blade.

It has been proposed at various times, instead of braking the saw blade, to lower the saw blade in a rapid movement in order thereby to bring it into a position below the workpiece support surface and consequently prevent the user's body part from still being able to come into contact with the saw blade. However, here too a large mass has to be moved within a very short period of time and especially with a very high initial acceleration, which entails problems in terms of the energy and generation of force for such acceleration and problems in terms of the load on all of the guide and bearing components of the panel saw.

A safety device which is also intended to be used for circular saws is generally already known from U.S. Pat. No. 9,702,916 B2. Dangerous situations are recognized in this case by means of a calibration and SNR calculation. When a dangerous situation occurs, simultaneously deactivation of the motor is effected and a cutting tool locking mechanism applied in order to stop the circular saw blade.

WO 2017/059 473 A1 discloses a method for detecting human tissue in the vicinity of a tool by means of recording a periodic change in capacity.

A safety system for circular saws is already known from US 2016/0 279 754 A9. Described in a list of alternative or additional detection measures and active measures are contact with or proximity to the saw blade as detection criteria for a dangerous situation, and a saw blade stop and saw blade lowering as active measures in a dangerous situation.

A safety system for circular saws, in which it is recorded by means of capacitive measurement if a body part comes into contact with the saw blade or approaches it, is already known from WO 2016/145 157 A1. Here, the motor is stopped when the body part approaches but if it makes contact a pyrotechnic braking device is ignited. Detection of the dangerous situation takes place capacitively.

WO 2015/091 245 A1 discloses an optical detection system for recording skin tones and the approach, calculated therefrom, of body parts to the saw blade. Stopping or lowering the saw blade are described as reaction mechanisms. A dangerous situation is detected here in the form of an approaching body part below a certain distance or a certain speed of approach being exceeded as a trigger criterion.

Determining a dangerous situation when a body part approaches the saw blade by recording the temperature by means of infrared is already known from US 2014/0 090 948 A1. The speed of an object is recorded and this recording comprises the direction of the movement and the movement rate. Depending on this speed recorded in this way, a decision is then made as to whether the drive is deactivated or whether a brake is activated.

WO 2013/046 522 A1 describes monitoring of a danger area using a triple sensor arrangement and stopping of the saw blade when an object enters this danger area. Only objects which reflect electromagnetic waves to a certain extent are recorded here and an RFID tag which is fastened at a far end of the thumb of a work glove is mentioned as an example. An alarm signal is output in parallel to stopping the saw blade in a dangerous situation.

WO 2014/164 964 A1 describes the recording of a workpiece, with recording the type of material of the workpiece, in order to optimize cutting parameters derived therefrom. The speed of a circular saw blade is regulated depending on these parameters. The workpiece is recorded by means of a material sensor in terms of its geometrical length in the cutting direction and the speed is lowered at the end of the cut in order as a result to reduce the formation of splinters and the associated risk of injury to the operator.

US 2011/0 226 105 A1 describes various safety devices on circular saws and relates to both the detection of a dangerous situation and the action in the case of a dangerous situation. To do this, different sensor systems for recognizing dangerous situations are disclosed and different actions described to avoid dangerous situations. These include halting the saw blade, lowering the saw blade, forming a protective shield around the saw blade (an airbag), and acoustic or optical signals. Levers shown in FIG. 16 which are intended to cover the cutting of the saw blade in dangerous situations do not seem to represent a reliably effective safety device from a technological point of view when the tool engages in a workpiece.

US 2009/0 301 275 A1 discloses the recognition of a human body part by means of electromagnetic waves within the wavelength range of 400 nm-1500 nm and avoidance of dangerous situations by covering the saw blade and stopping the saw blade. The document describes the recognition of the hand in a danger area as the triggering event.

A safety system for panel saws, in which quick lowering of the saw blade is likewise to be performed as a protective measure, is already known from EP 3 403 762. In this system, the sawing unit on which the saw blade is mounted is held in the sawing position by strong magnets against pretensioned springs. When the safety mechanism is triggered, the polarity of these magnets is reversed and they consequently accelerate the sawing unit vertically in a downward direction. Although it is in principle possible to effect a rapid lowering of the saw blade using the system, it is a disadvantage that the functional components needed to do this, such as the magnets and the pretensioning springs, increase the mass of the sawing unit which has to be moved for the quick lowering and consequently a considerable amount of kinetic energy is developed during the lowering which additionally can be controlled only to a very limited extent and therefore, despite complex cushioning mechanisms, result in a significant load on all the bearing elements and guides of the panel saw which can cause faults after the safety system has been triggered a certain number of times or can affect the precision and accuracy of the panel saw.

A safety apparatus for circular saws with stopping or lowering of the circular saw blade is already known from DE 10 2007 062 996 A1. Dangerous situations are recognized by a body part and its direction of movement in a danger area being recognized and otherwise the observation of two different movements and the comparison thereof is described.

DE 10 2008 001 727 A1 describes in principle a protection apparatus which describes detection by means of sensors, in particular distance sensors, and the action of lowering the saw blade into a protective position.

DE 10 2009 054 491 A1 describes a safety apparatus for circular saws which shuts down when a specifically designed glove of the operator is recognized. The position of this glove is determined with the aid of the recording of electromagnetic radiation in the UV range and covering of the circular saw blade by a guard is triggered depending on the glove entering a danger area.

DE 20 2010 004 458 U1 describes a safety system in which a sensor system records body parts in the region of the inlet front-end region. Recognition of the dangerous situation, performed according to a criterion, is described and, in order to prevent a dangerous situation, shielding of the circular saw blade or lowering of the saw blade below the table is described as an action.

DE 20 2011 101 566 U1 describes a quick lowering apparatus for the circular saw blade in order to avoid dangerous situations.

Up until now, none of the systems presented in these feasibility studies and basic research have been shown to be qualified for use in all types of circular saws including professional panel saws and been put into practice. The inventors have discovered that there are various reasons for this: firstly, the use in all types of circular saws and in particular in professional panel saws requires a high degree of acceptance from the user who forms a judgement about a safety system firstly in terms of operating safety but secondly also in terms of operational efficiency. Safety systems which significantly slow down the work processes and which are triggered unreliably because typical dangerous situations which occur in professional use are not recognized or which are triggered wrongly too many times because safe operating procedures are erroneously recognized as a dangerous situation cannot be used on professionally employed panel saws because, owing to the lack of acceptance by the user, they would either not be purchased at all or alternatively would be deactivated during day-to-day use after the deficiencies have been first been experienced.

Furthermore, professional panel saw users expect the safety system to be economical in terms of running costs. This includes in particular that triggering the safety system should entail only low costs, in particular also when preventive triggering takes place because of the system at the onset of dangerous situations and the possibility of a rapid restart of the panel saw after the protection apparatus has been triggered.

A further typical requirement for all circular saws and in particular panel saws in professional use is that the safety system functions for all the diverse applications of a circular saw. This includes in particular the use of large saw blades at high speed, sawing very thick solid wood and boards, sawing different materials including light metals, working with or without gloves, and operating a panel saw with more than one user. Safety systems for panel saws must here be designed for the typical accident scenarios which occur with panel saws, and the transfer from systems which, for example, reduce the risk of accident on table saws is already not possible because of the very different working position of the operator and the very different guidance of the workpiece (using both hands on one side of the saw blade in the case of the panel saw and using both hands on both sides of the saw blade in the case of the table saw).

Lastly, safety systems which are suitable for use on circular saws also have to function reliably, even in the case of rapidly repeated work processes with operation of the circular saws which often lasts for many hours or the whole day, such that approvals which are customary or even required in many countries by professional organizations such as, for example, trade associations or certification authorities can be obtained for the protection system.

### SUMMARY OF THE INVENTION

Against this background, the invention is based on the object of proposing a circular saw, in particular a panel saw, which has a system for protecting the operator from injuries on the saw blade and which is suitable for professional use on circular saws. The invention furthermore proposes a system for protecting the operator which affords improved protection from injuries on machine tools where there is a risk of injury, i.e., machine tools in which the operator's hand can come into the vicinity of a tool where there is a risk of injury during operation, which is here to be understood as use, set-up, maintenance, or cleaning. Such machine tools can in particular be machine tools for material-removal, shaping, or reshaping machining such as, for example, band saws, milling machines, lathes, EDM machines, folding machines, bending machines, casting systems such as injection-molding machines, cutting machines, or alternatively welding machines.

This object is achieved according to the invention by a circular saw comprising: a support surface for a workpiece, which has a saw blade slot, a main drive motor arranged below the support surface for driving a saw blade in rotational movement, a saw blade holder connected to the main drive motor for the purpose of transmitting the rotational movement and comprising a saw blade bearing unit and a saw blade flange which is mounted so that it can be rotated about a saw blade axis by means of the saw blade bearing unit and is designed to be connected to the saw blade so that it is fixed in torsion, a height-adjustment apparatus, with a height actuator and a transmission element coupled to the saw blade holder, which is arranged and designed to set the spacing between the saw blade holder and the support surface, an electronic interface for the input of a saw blade projection, a control device which is connected by signals to the electronic interface and to the height actuator and is designed to activate the height actuator such that a saw blade projection input via the user interface is set by means of the height actuator, and a protection apparatus for quickly lowering the saw blade in a dangerous situation having a monitoring apparatus for recording a dangerous situation, wherein it is provided that the protection apparatus is connected by signals to the monitoring device and the height actuator and is designed to activate the height actuator for quick lowering of the saw blade holder when the dangerous situation is recorded by the monitoring device.

The circular saw proposed according to the invention is characterized in that the saw blade is quickly lowered by means of an actuator and to do this the same actuator is used, namely the height actuator, which also serves to set a specific working height of the saw blade during regular operation. It is known in principle in the case of circular saws that the projection of the saw blade above the workpiece support surface can be set and, in the case of some modern circular saws, this is also possible by motorized adjustment using a height actuator. As a result, the saw blade can be moved to have a projection which is ideal for a high-quality cut on a workpiece of a certain thickness. Different drives are used as height actuators. It is customary and known to set the height of the saw blade by means of an electric drive, for example an electric motor, which sets the height of the saw blade via a mechanical element, by the sawing unit, and consequently the axis bearing, being raised or lowered.

According to the invention, the height actuator serves both to set the projection of the saw blade above the workpiece support surface and to quickly lower the saw blade below the table in a dangerous situation. For this purpose, the height actuator is activated both by a control device of the circular saw which sets the projection and by the protection apparatus which activates the height actuator for rapid lowering of the saw blade. Setting the projection of the saw blade and rapid lowering of the saw blade is here to be understood as meaning that, for example, the whole sawing unit, i.e., the saw blade including the bearing of the saw blade about the saw blade axis and possibly also the drive device with which the saw blade is set in rotation, is height-adjusted and rapidly lowered in the case of a safety system being triggered. In other designs, it is also possible that only parts thereof are raised and/or lowered, for example only an axle bearing unit of the saw blade.

By virtue of the use of the height actuator for the quick lowering in the case of the circular saw according to the invention, on the one hand, the need to install additional components in order to effect the quick lowering is avoided. Also avoided is the need to provide decoupling of the height setting from such additional components in order to be able to perform the quick lowering with a separate safety actuator and hereby not to work counter to the height actuator needed to set the projection. It is furthermore advantageous that the activation of the height actuator enables the lowering, controlled directly from the actuator, of the saw blade from a working position into a safe position and at the same time controlled braking of the movement with the aid of the height actuator. These advantages are achieved because the height actuator, by virtue of its necessary precise activation, features corresponding control capabilities for exact height setting. The inventors have discovered that the height actuator can also be designed and activated in such a way that both strong initial acceleration and controlled braking of the lowering movement are effected by the height actuator. The load placed on the circular saw by quick lowering can consequently be significantly reduced such that no damage occurs to the precision bearings and guides on the circular saw as a result of the quick lowering even when the quick lowering is carried out with large saw blades of a diameter up to 550 mm or even higher.

A saw blade holder is to be understood as a rotatably mounted fastening option for a saw blade which has the properties necessary for guidance and torque-transferring anchoring of a saw blade. The saw blade holder comprises a saw blade bearing unit which is configured as a sliding or rolling bearing or other bearing in order to enable the saw blade to move in rotation about the saw blade axis. Also comprised is a saw blade flange which is rotatably mounted about the saw blade axis by means of this saw blade bearing unit and serves to hold the saw blade. The saw blade flange can here be designed in particular to retain the saw blade by means of clamping, screwing, or other means of positive locking. This can take place, for example, by clamping the saw blade between two flange disks, by immobilizing the saw blade in the manner of a bayonet connection, or by screwing the saw blade by means of several screws or the like.

The height-adjustment apparatus has, on the one hand, a height actuator and, on the other hand, a transmission element. A height actuator is here to be understood as the motorized drive element, for example therefore an electric motor, a fluid drive, or the like. A mechanical element such as a spindle drive, a piston rod, a lever linkage, or the like which transforms the movement caused by the height actuator into height adjustment of the saw blade holder serves as the transmission element.

The circular saw furthermore has a control device which is connected to an electronic interface for the input of a saw blade projection. This electronic interface can be, for example, an input apparatus which can be operated by a user, for example a keypad, a touch screen, a voice recognition unit, or it can be configured as a data interface for the remote transmission of operating parameters. The control device generally comprises an electronic control system which is programmed to control various functions of the circular saw. According to the invention, the control device is at least designed to activate the height actuator in order to set an appropriate saw blade projection, based on a projection height input via the interface or on a parameter from which such a projection height can be derived.

The protection apparatus according to the invention serves to quickly lower the saw blade in a dangerous situation and consequently prevent contact between a body part of the user and the saw blade. A constituent part of the protection apparatus is a monitoring apparatus by means of which the dangerous situation is recorded. This monitoring apparatus can have a different design, for example it can be configured as an optical monitoring device which records the region around the saw blade with an imaging apparatus and makes a judgement about the movement of body parts and their dangerous position by means of image evaluation. Other options for a monitoring apparatus can comprise capacitive sensors, infrared sensors, or the like which are arranged adjacent to the saw blade in order to detect the approach of a body part.

If a dangerous situation is identified by the monitoring apparatus, the quick lowering of the saw blade can be controlled by the height actuator as a direct measure but possibly also as a downstream measure before a first or further measure such as a warning, a first safety measure, or the like. For this purpose, the height actuator is typically activated for a strong vertical downward acceleration of the saw blade and, once the danger has been eliminated by the lowering of the saw blade which has been achieved, can be braked again from this quick vertical movement by corresponding activation of the height actuator in order to cushion the lowering movement with the aid of the height actuator. After the lowering has been carried out and the dangerous situation resolved, the height actuator can furthermore be activated again in order to raise the saw blade into the original sawing position. As a result, without there being any need for further components or adjusting apparatus to do this, the rapid restoration of the working position on the circular saw is achieved after triggering for safety reasons such that no unnecessary delay to the work processes on the circular saw is caused by the triggering for safety reasons.

According to the invention, the activation of the height actuator is effected, on the one hand, by the control device of the circular saw and, on the other hand, by the protection apparatus of the circular saw. The control device can be addressed by the protection apparatus by signals, be a constituent part of the protection apparatus, or a part of the control device can be a constituent part of the protection apparatus. In principle, the control tasks can be carried out on the circular saw, both in terms of setting the normal operating parameters and in terms of the protective measures for avoiding accidents, by a central control device or by two or more separate, possibly redundant, control devices, one of which is responsible for setting the normal operating parameters and the other or others of which is or are responsible for the measures for avoiding accidents. The protection apparatus can in particular also comprise an evaluation unit which detects and assesses possible dangerous situations. Such an evaluation unit can, for example, be formed by two different computer units in order to carry out independent autonomous monitoring functions.

According to the invention, on the one hand, the setting of the projection height of the saw blade above the workpiece support surface as a normal operating parameter is effected by means of the height actuator and, on the other hand, the quick lowering of the saw blade is likewise effected by the height actuator. It is to be understood here that this quick lowering is carried out at a higher speed of movement of the saw blade than the setting of the saw blade projection. This is expedient both in terms of the required objectives, namely precise setting of a desired projection height, on the one hand, and as immediate lowering as possible of the saw blade, on the other hand, but also serves to treat the components of the circular saw gently because unnecessarily high acceleration is avoided in the course of setting the usual operating parameters, in this case the saw blade projection. For quick lowering of the saw blade, the protection apparatus thus activates the height actuator for a higher speed of movement than for a reduction in the saw blade projection by activation from the control device of the circular saw in the course of setting an operating parameter during normal operation.

According to a first preferred embodiment, it is provided that the height actuator is an electric servo motor. The inventors have found that an electric servo motor which is a constituent part of a servo drive is, on the one hand, well suited for ensuring exact setting of the saw blade projection, but, on the other hand, can also apply the power needed for quick lowering in order also to lower large saw blades rapidly into a risk-free position. The servo motor can here preferably act as a transmission element via a spindle drive. Such a spindle drive effects a favorable translation of the rotational movement of the servo motor into a translational movement which is required for raising and lowering the saw blade holder. This translation is suitable both for precise settings of specific heights and for high accelerations for the purpose of quick lowering.

According to a further preferred embodiment, it is provided that the protection apparatus or the control apparatus is designed in order, in a first operating mode to activate the height actuator for setting the saw blade projection, in a second operating mode to activate the height actuator for quick lowering of the saw blade, in a third operating mode preferably to activate the height actuator for restoring the saw blade to the original saw blade projection after quick lowering, and in a fourth mode preferably to activate the height actuator for setting a blade-change position, and the circular saw furthermore has a brake apparatus for frictional or positive immobilization of a blade-change position, and the protection apparatus or the control apparatus is further designed in order to activate the brake apparatus, after the blade-change position has been set by the height actuator, in order to immobilize the blade-change position.

According to this development, this circular saw is designed in order to activate the height actuator in two different operating modes. In the first operating mode, a saw blade projection is set and the height actuator is here activated for precise positioning of the saw blade axis at a specific height. In the second operating mode, the height actuator is activated for quick lowering. The control is here not a matter of positioning the saw blade axis exactly at a specific height but rather of lowering the saw blade in the shortest time possible in order to prevent injury to the user. The speed of movement at which the height actuator moves in the second mode is therefore greater than that in the first operating mode. In particular, the height actuator can be operated in the second operating mode at maximum power in order to achieve quick lowering. In addition, in the second operating mode, the downward acceleration of the height actuator can, on the one hand, be controlled, and the height actuator can be activated for braking of the downward movement in order to prevent a hard impact at the end of the travel.

In addition, a third operating mode is preferably provided with which the height actuator is moved, after quick lowering, into a normal operating state by the saw blade again having the same saw blade projection as before the quick lowering. In this third operating mode, a previously stored position of the saw blade axis is approached again. This approach movement can here take place in the same fashion and at the same speed as in the first operating mode. By virtue of this third operating mode, it is possible that, after a quick lowering has taken place, the circular saw is immediately returned again to the regular operating state and the operator can continue the sawing processes on the circular saw.

Lastly, a fourth mode is also provided in which the height actuator is driven in order to activate a blade-change position. In this fourth operating mode, a brake apparatus is additionally activated as soon as the saw blade has reached such a blade-change position. The blade-change position must allow the user to detach the saw blade from the saw blade holder and to fasten a different saw blade on the saw blade holder. This typically takes place in a lowered position of the saw blade holder. In principle, a height actuator can be designed such that it holds a specific position in a controlled fashion and consequently holds the saw blade axis stationary at a specific height. With such a controlled position, the saw blade projection can be set and maintained, for example, in the first operating mode. In particular, such initiation and maintenance of such a position is possible, for example, with servo motors as height actuators.

In the blade-change position activated in the fourth mode, it is necessary for the user to take hold of and remove the saw blade. For safety reasons, it is therefore preferred that this position is not maintained by means of controlling the height actuator and instead the position is secured by a brake apparatus separate from the height actuator in order to prevent an injury as a consequence of a possible regulating error of the height actuator when maintaining the position. The brake apparatus can here act frictionally on the height actuator or the transmission element such as the spindle or on other guide elements which guide the saw blade in the vertical adjustment in order to fix the position of the saw blade axis. Positive brake apparatuses can also be provided which effect an actual mechanical locking in the blade-change position.

According to a further preferred embodiment, it is provided that the saw blade holder and the saw slot are designed to receive saw blades with a diameter of more than 350 mm, preferably more than 400 mm or more than 450 mm, and the protection apparatus is designed in order to activate the height actuator and to activate the saw blade, in the case of quick lowering from a position with an original projection above the support surface into a lowered position with a final projection of the saw blade above the support surface which is smaller than the original projection.

It is fundamentally to be understood that according to the invention this embodiment can also be configured independently of whether the protection apparatus activates the height actuator. Just as effectively and alternatively, instead of the height actuator a different kind of actuator could also be activated in order to provide the quick lowering. In this case, two independent actuators would be present on the circular saw, one of which serves to set a saw blade projection and the other serves to effect quick lowering of the saw blade.

This aspect of the invention is based on the fact that the inventors have discovered that, because of structural restrictions or because of power restrictions, it is often not possible to perform quick lowering in which the saw blade is lowered completely below the workpiece support surface if the saw blade diameter exceeds 350 mm, exceeds 400 mm, exceeds 450 mm, or exceeds 500 mm. Depending on the size of the circular saw and structural design of the sawing unit, the problem arises above a certain maximum size that complete lowering of the saw blade is not possible. The problem here is not only that the quick lowering cannot successfully take place in order to achieve complete lowering purely geometrically but also that, in the case of lowering as far as the maximum possible geometrical limit, a hard impact ends the quick lowering and this can result in damage to the circular saw especially in the case of large saw blades owing to their high inertia. The inventors have, however, recognized that these limitations do not provide a reason for rendering the protection apparatus inoperative for large saw blades or for restricting circular saws with a corresponding accident prevention function to saw blades below the abovementioned maximum sizes. This is because a measure which is generally sufficient for preventing accidents can consist in quickly lowering a large saw blade into a position in which it still protrudes above the workpiece support surface. The inventors have discovered, on the one hand, that, because of the circular contour of the circular saw blade, in the case of vertical lowering, a spacing between a body part horizontally approaching the saw blade and the saw blade outline which is greater than the distance by which the saw blade axis was lowered is already generated by the first distance initially covered by the saw blade axis in the vertical direction. This results from the arrangement of the saw blade axis below the workpiece support surface and the orientation, caused thereby, of the tangents around the outer circumference of the circular saw blade.

This “translation,” which is to be understood as translation of a small vertical lowering travel into the generation of a large horizontal distance, makes it possible for the horizontal spacing between a body part approaching the saw blade and the saw blade outer circumference to be changed rapidly, even in the case of large saw blades, such that an accident can be avoided. At the same time, the user is made unambiguously aware of the risk by the quick lowering which takes place and prompted to alter or stop the dangerous movement of the body part, as a result of which the accident can be reliably avoided in many cases. The only partially performed lowering can additionally be used also to perform braking, using the lowering actuator, in particular the height actuator, before the geometrically determined end of the travel in order to avoid a hard impact at the end of the travel.

It is in particular preferred to connect the partial lowering movement of large saw blades to a simultaneous quick braking of the rotation of the saw blade. It can consequently be achieved that the saw blade initially avoids injury by the partial quick lowering by creating a horizontal spacing from the body part, and that, when the partially lowered state of the circular saw blade is reached, the latter is brought to a standstill in rotation such that a serious cut injury is avoided even when the body part then comes into contact with the saw blade.

According to a further preferred embodiment, it is provided that the protection apparatus is designed in order to activate the height actuator for quick lowering in an acceleration phase in which the saw blade holder is accelerated downward to a lowering speed, and thereafter to activate it in a braking phase in which the saw blade holder is braked from the lowering speed.

According to this embodiment, the movement of the circular saw blade comprises at least two phases in the case of quick lowering. In a first phase, the saw blade is accelerated vertically downward by the height actuator and is consequently accelerated from standstill to a downward directed speed. After this acceleration phase, possibly directly following this acceleration phase, the height actuator is activated by the protection apparatus for a braking phase. In this braking phase, the height actuator slows down the downward movement in order to prevent a hard impact at the end of the lowering travel. This braking phase can be controlled such that the saw blade holder is braked to a standstill before the end of the travel. Alternatively, a braking phase can also be controlled such that, when it reaches the end of the travel, the saw blade holder still has a residual speed which is absorbed by a corresponding stop, damper, buffer, or the like. The transition between the acceleration phase and the braking phase can be effected by a time control system or by a travel control system and a phase with a constant speed can also exist between these two phases. It is in principle preferred if the braking phase is initiated as soon as the saw blade no longer projects above the workpiece support surface, i.e., has been lowered completely below the workpiece support surface. However, in the case of large saw blades, the braking phase can also be initiated already when the saw blade still projects above the workpiece support surface in order to avoid a hard impact at the end of the travel. This applies in particular when the saw blade is so large that it is not lowered completely below the workpiece support surface.

It is further preferred if the protection apparatus is designed in order to activate the height actuator for a transition from the acceleration phase into the braking phase as soon as a deceleration calculated from a calculated braking distance and the current lowering speed of the saw blade exceeds a predetermined maximum deceleration, wherein the calculated braking distance is calculated by subtracting the current depth of descent from a predetermined maximum depth of descent of the saw blade, or a calculated braking distance is less than 50 mm, wherein the calculated braking distance is calculated by subtracting the current depth of descent from a predetermined maximum depth of descent of the saw blade, and/or the saw blade axis is below the support surface by a distance which is greater than or equal to half the diameter of the saw blade when the height-adjustment apparatus has an adjustment travel which is at least 50 mm greater than half the saw blade diameter.

According to this embodiment, the transition from the acceleration phase into the braking phase is initiated in accordance with three alternative criteria. The development is to be understood here such that, in one alternative embodiment, only one of these three criteria is implemented in the control system and the transition between the acceleration phase and the braking phase is set solely according to this control system alternative. In a second alternative embodiment, two or all three criteria are saved in the control system and a calculation is made, synchronously during the lowering or with the aid of previously specified geometrical values such as the saw blade diameter, the saw blade projection, and the maximum travel, as to when the transition takes place from the acceleration phase to the braking phase. In this second alternative embodiment, the braking phase is initiated as soon as one of the criteria is met.

It should fundamentally be understood in the case of both alternative embodiments that the limit value for the calculated braking distance can be 50 mm but, as an alternative, other limit values can also be used in the criterion depending on the design of the height-adjustment apparatus, for example less than 25, 30, 40, 60, 70, 80, 90, or 100 mm. In addition, the limit value of the braking distance can also be determined depending on parameters such as the saw blade diameter or the saw blade weight such that a variable limit value is used taking into account the kinetic energy which is generated when the saw blade is accelerated downward. The criteria ensure that, under the typical parameters of use of circular saws, i.e., typical circular saw blade diameters, blade projections, sufficiently gentle braking of the quick lowering from the acceleration phase is achieved therefrom and as a result damage to guides and bearings of the circular saw caused by the quick lowering is avoided.

The invention was described above with reference to the quick lowering of a circular saw blade by means of a height actuator. It should be understood that the invention and the above-described aspects of the movement control can also be used for other machine tools, in addition to this application for circular saws, in which a tool with which there is a risk of injury has to be removed as quickly as possible from a danger area when a dangerous situation for the operator which is caused by the tool has been identified. Also in the case of such other machine tools, an actuator which is provided for a purpose other than setting, feeding, or advancing the tool can advantageously be activated for such a rapid safety movement of the tool into a safety position and designed accordingly in order to execute both the precise tool setting movement and the rapid safety movement. Thus, for example, a milling tool can be moved from a danger area rapidly away from the operator.

Within this sense, the invention also comprises a safety apparatus for a machine tool, comprising:
a tool with which there is a risk of injury,
an adjustment actuator which is coupled to the tool in order to carry out a movement of the tool necessary for workpiece machining,
an electronic interface for the input of a tool position,
a control device which is connected by signals to the electronic interface and to the adjustment actuator and is designed to activate the adjustment actuator such that a tool position input via the user interface is set by means of the adjustment actuator,
a protection apparatus for initiating a safety measure such as, for example, to move the tool quickly in a dangerous situation with a monitoring apparatus for recording a dangerous situation,
   characterized in that the protection apparatus is preferably connected by signals to the monitoring apparatus and the adjustment actuator and is designed to activate the adjustment actuator for quick displaced movement of the tool when the dangerous situation is recorded by the monitoring device.

The explanation above and below applies analogously for this aspect, wherein the adjustment actuator corresponds to the height actuator, the tool corresponds to the saw blade or the saw blade holder, the tool position corresponds to the saw blade height, and the quick displaced movement corresponds to the quick lowering.

The protection apparatus can, as a safety measure, for example in the case of machine tools which do not allow quick displaced movement of the tool or in which this would not result in a reduction of the danger, also carry out another measure such as, for example, enclosing, shielding, or stopping the tool movement, releasing a pretensioning force, pressure, or reduced pressure, or the like in order thereby to reduce or avoid altogether the danger for the operator.

According to a further preferred embodiment or an independent further aspect of the invention, it is provided that the protection apparatus is designed to receive a saw blade diameter and a saw blade projection via an input interface and to specify from the saw blade diameter and the saw blade projection a danger area, around the saw blade, situated inside a monitoring area monitored by the protection apparatus, wherein the danger area is specified by the control device as larger for a large saw blade diameter than for a small saw blade diameter and/or the danger area is specified by the control device as larger for a large saw blade projection as larger for a large saw blade projection than for a small saw blade projection, wherein the protection apparatus is designed to determine, with the aid of the location and the movement of a hand of a user which is recorded by the protection apparatus in the monitoring area, within what period of time the hand would enter the danger area, and to perform quick lowering of the saw blade when the determined period of time is less than a predetermined warning time.

It is fundamentally to be understood that this embodiment can be configured in connection with the above-described circular saw or machine tool if the protection apparatus is connected to the monitoring device and the height actuator by signals and is designed to activate the height actuator for quickly lowering the saw blade holder when the dangerous situation is recorded by the monitoring device. In the same and an alternative way, it can, however, also be configured differently and the protection apparatus can activate a separate actuator for the quick lowering such that the height actuator in this case does not execute the dual function of setting a saw blade projection and quick lowering and instead only sets the saw blade projection.

The development is based on the insight that, for practicality and relevance of a protection apparatus, the number of faulty triggerings needs to be as low as possible but at the same time a sufficient degree of safety from cut injuries needs to be obtained by the protection apparatus for all operating situations. The inventors have identified as parameters influencing this that, on the one hand, the saw blade diameter or in other machine tools generally a dimension of the tool and, on the other hand, the saw blade projection or in other machine tools generally a position of the tool have an influence, wherein the functioning is described below by way of example with the aid of the saw blade diameter and the saw blade projection. Thus, it is firstly the case that tasks are often carried out during practical use which include cutting guiding movements in which the user has to move their hands past and close to the saw blade, to do which smaller saw blades and smaller saw blade projections are generally used. In contrast, large saw cuts are often made with high energy usage and also a higher pushing force from the user with large saw blades and large saw blade projections. This results in the need, in the case of more delicate tasks with small saw blades and saw blade projections, for the protection apparatus to trigger the quick lowering only at smaller approach distances of a body part to the saw blade than in the case of large saw blades and large saw blade projections.

The inventors have additionally discovered that, in the case of smaller saw blades and smaller saw blade projections, because on the one hand of the lower inertia of these saw blades and because of the shorter distance by which such a saw blade has to be lowered in the case of such a saw blade projection in order to disappear completely below the workpiece support surface, quick lowering can take place with the exertion of a smaller amount of energy than larger saw blades and/or saw blades with a larger saw blade projection. For the same reasons, a smaller saw blade and/or a saw blade with a smaller saw blade projection can be lowered more quickly with the same energy use than a larger saw blade and/or a saw blade with a larger saw blade projection.

In order to equip the circular saws according to the invention for this professional use with a practical protection apparatus, it is therefore provided that a monitoring area in which body parts of the user, for example the user's hands, are recorded is monitored by the protection apparatus, and that a danger area of variable size is defined within this monitoring area. This danger area describes a delimited space or a delimited surface about one or more danger points, for example the teeth of the saw blade or the point at which the circumference of the saw blade meets the workpiece support surface or the upper plane of the workpiece. If it is determined by monitoring the user's body part that, starting from a recorded position, this body part moves such that it enters the danger area within a predetermined advance warning time, quick lowering is triggered by virtue of this identification. It is fundamentally to be understood that the danger area is used as the directly injury-triggering criterion for assessing a dangerous situation. This does not, for example, exclude the possibility that a larger advance warning area is defined inside the monitoring area and the calculated entry of a body part into this advance warning area is used to produce an advance warning signal within the sense of a cascaded reaction of the protection apparatus. The invention here consists fundamentally in specifying the size of the danger area depending on at least one dimension of the tool and/or depending on at least one spacing of the tool from a secured position in which a risk is avoided or reduced. As a result, the protection apparatus according to the invention can also ensure that the operator is safe from injury in the case of large tools and/or when the tool has moved a long way from a secured position.

According to the invention, the danger area is in principle to be understood not only in the sense of a physical space or a physical surface and instead can also be implemented by corresponding adaptation of the advance warning time. The advance warning time here represents a period of time which is compared with a calculated time in which a body part would reach the danger point and the quick lowering is triggered when this period of time is less than the advance warning time. In this alternative, starting from a danger point, as defined above, an advance warning time is, for example, adapted depending on the saw blade diameter and/or the saw blade projection. Therefore, whereas in the first case delimitation of a space or a surface which defines the danger area is chosen to be larger in the case of a large saw blade diameter or a large saw blade projection than in the case of a correspondingly small saw blade diameter or saw blade projection in order to ensure a practical sensitivity of the protection apparatus, in the case of the alternative definition of the danger area such a geometrical limit would not be shifted and instead an advance warning time would be lengthened such that, in the case of a large saw blade diameter/saw blade projection, the quick lowering is already triggered when the current position and movement of a body part would result in contact with the saw blade within a period of time which is longer than would be set in the case of a small saw blade diameter or small saw blade projection.

Other parameters can additionally or alternatively also be taken into account in addition to the saw blade diameter and the saw blade projection in order to make an adaptation to the size of the danger area or the advance warning time. A calculation can thus be made, for example, from the position, speed, and acceleration of a body part as to when the body part would reach the saw blade or a danger point on the saw blade and, depending thereon, the danger area or the advance warning time are enlarged or reduced in order to ensure a sufficient safety buffer. The angle between the tangent at the saw blade circumference at a point which lies in the workpiece support surface or the upper side of the workpiece and the workpiece support surface can also be determined and taken into account. This tangential angle influences the rate at which the horizontal spacing between a body part and the saw blade changes with reference to a vertical lowering of the saw blade. In principle, large tangential angles are disadvantageous for rapid generation of a horizontal distance by lowering the saw blade, whereas small tangential angles are advantageous because in the case of small tangential angles a large horizontal distance between the body part and the saw blade can already be generated with a short lowering distance. Accordingly, the danger area or the advance warning time in the case of small tangential angles can also be chosen as smaller than in the case of large tangential angles. Lastly, the speed of the saw blade can also be taken into account when dimensioning the danger area or the advance warning time especially in the case of large saw blades which cannot be lowered completely below the workpiece support surface because the braking of the saw blade to a standstill in rotation can also be taken into account in the safety design for these large saw blades and this braking process can be longer or shorter depending on the speed.

According to a further preferred embodiment, it is provided that the saw blade holder is connected to the main drive motor by means of a multiple ribbed belt which is tensioned to a belt tension by means of a self-adjusting belt tensioning device, and that the main drive motor is a three-phase AC motor and the control device or the protection apparatus is designed to simultaneously brake the main drive motor for the purpose of quick lowering by the injection of direct current and, in an initial braking phase, feed in braking direct current at a predetermined level of current and reduce the braking direct current after a predetermined braking time, wherein the belt tensioning device is preferably designed to set the belt tension at between 90% and 100% of an upper limit of a predetermined belt tensioning range.

This embodiment is also suited to serve either as a development of the embodiment in which the height actuator is activated by the protection apparatus or as an independent aspect which also represents an advantageous embodiment of a protection apparatus when the protection apparatus activates a separate actuator for quick lowering.

According to this embodiment, it is provided that the rotation of the saw blade in the case of quick lowering is stopped in parallel, i.e., either beginning at the same time, in advance, or with a delay. It is provided here that the saw blade is driven by a main drive motor via a multiple ribbed belt. This form of drive has proven to be effective in terms of the transmissible speeds and torques and quiet running. However, such a multiple ribbed belt has the disadvantage that it can slip in the case of particularly high torques on the belt pulley and consequently achieves no or only reduced torque transmission. It is therefore provided that a self-adjusting belt tensioning device tensions the multiple ribbed belt to a belt tension such that strong braking can be transmitted by injecting braking current into the drive motor. It is consequently advantageously achieved there is no need to arrange an additional brake on the circular saw and instead the braking power is introduced via the main drive motor by corresponding activation of the three-phase AC motor. It should fundamentally be understood that this embodiment can also be applied to other machine tools and tools in which the tool is driven via a belt drive or otherwise via static friction such as, for example, in the case of a band saw which has such a means of transmission between the tool itself (the saw band) and the driven drum about which the saw band is looped, or to the further machine tools listed above.

It is here more preferably preferred that the level of the direct current which is injected into the three-phase AC motor for the purpose of effecting braking is reduced after an initial braking phase, starting from an initial level. This can take place after a predetermined braking time or can be effected if the speed of the main drive motor falls below a certain level. This reduction in the braking direct current prevents the reinforced braking effect which builds up from causing slipping of the multiple ribbed belt during the whole braking phase, which causes a significantly reduced braking torque transmission because of the sliding friction which is then applied between the multiple ribbed belt and the belt pulley, compared with the static friction that generally exists between the multiple ribbed belt and the belt pulley.

It is particularly preferred if the belt tension is set at between 90% and 100% of a predetermined belt tension upper limit. Multiple ribbed belts generally have a technically predetermined maximum belt tension and should not be tensioned beyond this belt tension because they can become damaged as a result. The drive torque for the purpose of operating a circular saw can generally also be reliably transmitted with belt tensions which are less than 90%, for example less than 85% or even less than 80% of this maximum belt tension. It is, however, advantageous for the purpose of quickly braking the saw blade if the multiple ribbed belt is tensioned more strongly and is maintained by the tensioning apparatus in the said range above 90% of the maximum belt tension.

It is furthermore particularly preferred if the protection apparatus comprises a monitoring device with an image capture apparatus and an image evaluation device and the image evaluation device is connected by signals to the height actuator in order to activate the height actuator when a dangerous situation is identified for quick lowering of the saw blade holder.

By virtue of such a monitoring device with an image capture apparatus and an image evaluation device, on the one hand reliable monitoring of the movement of body parts in the vicinity of the circular saw blade is achieved and, on the other hand, specification of the monitoring area and of a monitoring area can be implemented particularly advantageously with calculation of an advance warning time or extension or reduction of the monitoring area depending on different parameters. The monitoring device can in principle be used for all types of machine tools where there is a risk of injury, in particular in conjunction with and as a constituent part of a protection apparatus of the type explained above.

A further aspect of the invention is a circular saw comprising: a support surface for a workpiece and which has a saw blade slot, a main drive motor arranged below the support surface for driving a saw blade in rotational movement, a saw blade holder connected to the main drive motor for the purpose of transmitting the rotational movement and comprising a saw blade bearing unit and a saw blade flange which is mounted so that it can be rotated about a saw blade axis by means of the saw blade bearing unit and is designed to be connected to the saw blade so that it is fixed in torsion, a protection apparatus for quickly lowering the saw blade in a dangerous situation with a monitoring apparatus for recording a dangerous situation and a height-adjustment apparatus, with a height actuator and a transmission element coupled to the saw blade holder, which is arranged and designed to lower the saw blade holder when a dangerous situation is identified by the monitoring device, which is characterized in that the monitoring apparatus comprises an image capture apparatus and an image evaluation device and the image evaluation device is connected by signals to the height actuator in order to activate the height actuator when a dangerous situation is identified for quick lowering of the saw blade holder.

According to this aspect, a circular saw is proposed which has a protection apparatus for avoiding work accidents in order to prevent cut injuries on body parts of the user. Image capture is performed here in order to identify whether a body part is approaching the saw blade in a dangerous fashion. To do this, the image capture apparatus can record and monitor a monitoring area and, when body parts are identified in it which, on the basis of a position, speed of movement, and/or acceleration determined for this body part, are approaching a danger point on the saw blade or a danger area around the saw blade, effect corresponding quick lowering of the saw blade by activating the height actuator.

It is fundamentally to be understood that this circular saw can be developed with the technical aspects and development measures which have been described above. It is furthermore to be understood that this aspect of the invention too can, in addition to application to circular saws, also be used for other machine tools in which a dangerous situation for the operator which is caused by the tool has to be identified. The subject of the invention is consequently also a machine tool which has a protection apparatus for avoiding work accidents in order to prevent cut injuries on body parts of the user, in which image capture is performed in order to identify whether a body part is approaching the tool in a dangerous fashion. To do this, the image capture apparatus can record and monitor a monitoring area and, when body parts are identified in it which, on the basis of a position, speed of movement, and/or acceleration determined for this body part, are approaching a danger point on the tool or a danger area around the tool, trigger a safety measure such as, for example, quick removal/shielding/braking of the tool.

It is furthermore preferred if the image capture device comprises a first camera and a second camera and the image evaluation device comprises a first and a second image evaluation unit, and the first camera and the second camera are arranged at a spacing from each other above a workpiece support surface of the circular saw or machine tool and each have a recording direction which is oriented in the direction of the workpiece support surface, wherein the first camera is connected by signals to the first image evaluation unit which is designed to receive the image data from the first camera and process the data by means of a first piece of evaluation software of the control device in order to identify whether a dangerous situation exists, the second camera is connected by signals to the second image evaluation unit which is designed to receive the image data from the second camera and process the data by means of a second piece of evaluation software of the control device in order to identify whether a dangerous situation exists, wherein the first piece of evaluation software is different from the second piece of evaluation software and/or the first image evaluation unit is different from the second image evaluation unit.

According to this embodiment, the image capture device is formed by at least two cameras spaced apart from each other which for their part perform image capture of an area of the workpiece support surface. The two areas which are captured by the two cameras can overlap partially or completely but can also be separate from each other and be joined together in this way to form a whole monitoring area. The image evaluation device is also comprised by a first and a second image evaluation unit, wherein the first image evaluation unit is associated with the first camera and the second image evaluation unit is associated with the second camera. Independent image capture and image evaluation using separate image capture units (cameras) and separate image evaluation units are obtained as a result, this being advantageous because, in the event of one camera or one image evaluation unit failing or malfunctioning, the whole protection apparatus does not become inoperative. In particular when the immediate danger area around the saw blade is advantageously captured by both cameras in an overlapping fashion, independent redundant monitoring of this danger area can be achieved as a result by the image capture device and image evaluation device.

It is particularly preferred here if the first piece of evaluation software has a first operating system running on the first image evaluation unit and a first image evaluation algorithm running on the first image evaluation unit, the second piece of evaluation software has a second operating system running on the second image evaluation unit and a second image evaluation algorithm running on the second image evaluation unit, wherein the first and the second image evaluation unit are different from each other, or the first and the second operating system are the same as each other and the first and the second image evaluation algorithm are different from each other, or the first and the second operating system are different from each other and the first and the second image evaluation algorithm are the same as each other, or the first and the second operating system are different from each other and the first and the second image evaluation algorithm are different from each other.

According to this development, the hardware, operating system, and/or software of the two image evaluation units are different from one another in order to provide redundancy which ensures reliability. For this purpose, it is provided that the first piece of evaluation software on the first image evaluation unit and the second piece of evaluation software on the second image evaluation unit are different and/or that the first image evaluation unit or the second image evaluation unit are different from each other. By virtue of this difference, a difference is achieved either in the case of the hardware of the image evaluation device or in the case of the software, i.e., the operating system or the evaluation software or both, which are installed on the image evaluation unit. This difference is advantageous because possible systematic errors which cause faulty recognition, failure, or partial incorrect assessment of dangerous situations do not necessarily have to occur in parallel and synchronously in both image evaluation systems. Instead, redundancy resulting in greater evaluation certainty can in turn be obtained by the different hardware and/or different software.

It is further preferred here if the image evaluation device is designed to evaluate image data from a monitoring area and image data from a danger area, wherein the danger area is arranged inside the monitoring area and comprises a danger point at which a user could be injured on the saw blade, wherein a surface unit in the danger area is captured by the first or second camera with more pixels than a surface unit of the same size in the monitoring area.

According to this development, a different resolution in the danger area and in a monitoring area arranged around the danger area is achieved by the design of the camera, the arrangement of the camera, or the configuration of the sensor surface of the camera. As a result, the quantity of data to be evaluated for monitoring body parts in the monitoring area and in the danger area is reduced and the necessary resolution adapted to the respective dangerous situation by objects in the monitoring area being captured with a lower resolution than in the danger area. This makes it possible to perform the image evaluation efficiently and quickly and consequently, even when several body parts have to be evaluated at the same time inside the monitoring area or danger area, to perform risk analysis which takes place in real time by means of the image evaluation, and to reliably provide the prevention of accidents as a result.

It is further preferred if the image evaluation device is designed to receive operating parameters of the circular saw or the machine tool and to alter the size of the danger area depending on the operating parameters of the circular saw or the machine tool.

As explained above, the size of the danger area can here analogously be replaced by the length of an advance warning time. This danger area or this advance warning time can be altered on the basis of operating parameters of the circular saw. For example, in the case of large saw blades, large saw blade projections, and/or high saw blade speeds, the danger area can be chosen as larger or the advance warning time as longer than in the case of smaller saw blade diameters, smaller saw blade projections, and/or lower saw blade speeds. Further operating parameters can also be taken into account for the purpose of adapting the size of the danger area. The motor current of a drive motor of the circular saw blade can thus, for example, be used to determine the current cutting power of the saw blade which is a measure of the pushing force exerted by the user, and it can consequently be taken into account that, in the case of high pushing forces to be exerted by the user, there can also be a greater risk of injury with in particular the risk of the user's hand accelerating quickly when it slips, which results in enlargement of the danger area/lengthening of the advance warning time as a preventive measure.

It is here in particular preferred if the operating parameters include a diameter of the saw blade used and a saw blade projection of the saw blade used above the workpiece support surface or corresponding parameters of a machine tool and the image evaluation device is designed to specify, from the saw blade diameter and the saw blade projection, an entry point and/or an exit point of the saw teeth arranged at the circumference of the saw blade into or from the workpiece support surface as danger points and to place the danger area around one or both danger points as a predetermined geometry.

According to this development, one or two danger points which correspond to the points of intersection of the outer circumference of the circular saw blade and the workpiece support surface are determined from certain operating parameters, namely the diameter of the saw blade used and a saw blade projection. Instead of the workpiece support surface, the upper workpiece surface can here also be used which can be determined, for example, from an input workpiece thickness, a recorded positional height of a guard which is placed over the workpiece. The danger points thus determined can therefore serve to specify the danger area precisely. In particular, by virtue of this calculation, in the case of small saw blades or small saw blade projections, it can be avoided that quick lowering is already triggered when a hand approaches the saw blade in an as yet non-critical manner, as for example would be the case if the danger area had been specified as a fixed surface area around the saw blade. In particular when large saw blades are used, possibly with large saw blade projections above the workpiece support surface, it is furthermore possible to specify exactly the danger point and to recognize a dangerous situation therefrom more accurately with the advantage of fewer incorrect triggerings and reliable triggering in the case of an actual dangerous situation. Lastly, when the upper surface of the workpiece is used to specify the danger point, exact specification of the actual danger point is also achieved when the saw blade is slanted, it being possible for this danger point to be situated in such a case horizontally offset relative to the saw slot and above the workpiece support surface.

It is further preferred if the operating parameters include a diameter of the saw blade used and a saw blade projection of the saw blade used above the workpiece support surface and the image evaluation device is designed to define the danger area as larger in the case of a large saw blade diameter than in the case of a small saw blade diameter, to define the danger area as larger in the case of a large saw blade projection than in the case of a small saw blade projection, and/or to specify, from the saw blade diameter and the saw blade projection, a tangential angle between the tangent at the circumference of the saw blade in the workpiece support surface to the workpiece support surface, and to define the danger area as larger in the case of a large tangential angle than in the case of a small tangential angle.

According to this development, one, two, or three additional parameters are taken into account in order to specify the size of the danger area. It is here, on the one hand, taken into account that a saw blade with a large diameter can be quickly lowered more slowly than a saw blade with a small diameter and in the same way a saw blade in a position with a large saw blade projection can be quickly lowered more slowly than a saw blade from a smaller saw blade projection. Furthermore, the tangential angle also plays a role in avoiding accidents because, in the case of a small tangential angle, a significant horizontal spacing is already created between a body part approaching the saw blade and the danger point in the case of a small vertical lowering distance, whereas, in the case of a large tangential angle, the ratio between the horizontal distance, created between the saw blade and the body part, and the vertical lowering distance is unfavorably smaller and consequently it is not possible to obtain a favorable large horizontal spacing between the body part and the saw blade already over the first centimeters of the lowering movement.

It is furthermore preferred if the image evaluation device is designed to identify a dangerous situation if a user's body part recognized by the image capture device is arranged such that the guard is located between a portion of the body part and the image capture device, in particular if the guard is located in an optical path of a first camera or a second camera of the image capture device and a portion of the body part.

According to this embodiment, it is provided that quick lowering is triggered as soon as a body part recognized by the image evaluation is located below a guard which surrounds the circular saw blade. This embodiment is advantageous because, on the one hand, in such a case the body part has approached the saw blade in a critical manner and, on the other hand, the further movement of the body part below the guard can no longer be reliably determined by the image capture device and consequently the existence of a dangerous situation can no longer be recognized reliably.

It is further preferred if the circular saw comprises a guard arranged above the workpiece support surface and which partially encloses the saw blade and is height-adjustable, and if the guard can then be moved away from a position above the saw blade slot into a position next to the saw blade slot, and the image evaluation device is designed to specify, in the case of a guard moved away from the position above the saw blade slot, an outline or part of an outline of a virtual guard, and to identify a dangerous situation when a user's body part recognized by the image capture device is arranged such that the outline or part of the outline is located between a portion of the body part and the image capture device, in particular when the outline or part of the outline is located in an optical path of a first camera or a second camera of the image capture device and a portion of the body part, wherein the image evaluation unit is preferably designed to determine a position of the guard or the circular saw comprises a position sensor which records a position of the guard.

It is fundamentally provided that a guard is intended to surround the saw blade when the circular saw is being used and is raised only far enough that the workpiece can be pushed through the saw blade under the guard. However, in the case of some applications, in particular when hollow items have to be sawn, it is unavoidable that the guard has to be pivoted away. In such a case, there is, on the one hand, an increased risk of injury and, on the other hand, the area immediately around the saw blade is no longer protected by the guard and covered as an area. It is therefore advantageous if in such a case, when the guard is pivoted away, a virtual area is defined around the circular saw blade which corresponds to the area normally covered by the guard and quick lowering is triggered when a body part is arranged in this virtual area. In this way, the critical approach of a body part can be identified immediately as a dangerous situation, even when the guard is pivoted away, and an injury accordingly avoided.

It is here in particular further preferred if the width of the virtual guard is greater than the area covered by the saw blade, projected onto the workpiece support surface, from the camera perspective. This development is advantageous in particular for tilted positions of the saw blade, i.e., for positioning of the axis of rotation of the saw blade in a non-parallel arrangement relative to the workpiece support surface, in order thereby to carry out an angled or mitre cut.

It is further preferred if the circular saw furthermore comprises: a guard arranged above the workpiece support surface and which partially encloses the saw blade and is height-adjustable, a guard height sensor which is designed to determine the height of the guard above the workpiece support surface, wherein the control device is designed to form a height-comparison value on the basis of a comparison between the guard height above the workpiece support surface determined by the guard height sensor and the saw blade projection, and to output a warning signal if the height-comparison value exceeds a predetermined height-comparison threshold value.

According to this embodiment, the height positioning of a guard is compared with the saw blade projection of the circular saw blade by the two values being read from corresponding sensors. Using this comparison, a plausibility test can be performed which helps to recognize if the guard has been wrongly adjusted to be too high and consequently the spacing between the upper side of a workpiece and the under edge of the guard is too big. In such a case, a warning signal can be output to alert the user to the incorrect setting of the guard. Quick lowering of the saw blade may also be performed in order to avoid the dangerous situation: this can take place in particular when, in spite of a previously output warning signal, the user does not make any correction to the position of the guard and instead performs the sawing procedure, it being possible for this to be recognized, for example, on the basis of the rotation of the saw blade or the motor current.

According to a further preferred embodiment, it is provided that the image capture device comprises a first camera and a second camera, and the first camera has a first image capture surface with a first area centroid which is arranged on a first side of the saw blade slot in the workpiece support surface, and the second camera has a second image capture surface with a second area centroid which is arranged on a second side, opposite the first side, of the saw blade slot in the workpiece support surface, wherein the spacing between the first area centroid and the saw blade slot is less than the spacing between the second area centroid and the saw blade slot.

According to this embodiment, the image capture is carried out with two cameras which are arranged spaced apart from each other and which each capture a surface on the workpiece support surface and are arranged on the left-hand and right-hand side of the saw blade slot. It is achieved as a result, on the one hand, that it can as far as possible be avoided that the field of view is covered by the saw blade or a guard above the saw blade, and the monitoring area and the danger area around the saw blade can thus be captured well by the image capture apparatus. The two area centroids of the image capture surfaces are preferably situated at different distances from the saw slot. Asymmetry in the arrangement of the cameras and their image capture direction is obtained as a result which is non-critical in terms of possible covering effects by objects in the area between the workpiece support surface and the cameras.

It is further preferred here if the first and the second image capture surface overlap in an overlap area and the overlap area covers the saw blade slot and preferably has a surface size which is more than 50% of the surface size of the first image capture surface.

The image capture surfaces of the two cameras overlap; this overlap area is situated in the region of the saw blade. Reliable redundant capture of the direct danger area around the saw blade by both cameras is obtained by virtue of this overlap. This configuration is provided according to the invention for circular saws, band saws, and other forms of saw, as well as for other machine tools in which there is the risk of corresponding covering of the field of view of a camera.

According to a further preferred embodiment, it is provided that the protection apparatus is designed to perform an initialization process in which the hands of each user of the circular saw or the machine tool are recorded by the monitoring device, wherein the initialization process must be performed preferably every day at least once before the first sawing procedure or machining procedure in order to carry out a sawing procedure or machining procedure, and the protection apparatus performs quick lowering of the saw blade or a safety measure if the monitoring device recognizes a hand in the monitoring area which was not recorded in a preceding initialization process.

According to this embodiment, the protection apparatus of the circular saw is, on the one hand, configured to record in an initialization process the hands of one or more users which are to be monitored by the protection apparatus in subsequent use of the circular saw. This initialization process is necessary for reliable operation of the circular saw in order to avoid body parts which cannot be recorded reliably by the protection apparatus appearing in the monitoring area and the possibility that the user or a further user who joins them wrongly assumes that the protection apparatus performs a monitoring function of such body parts. It is therefore provided that, if a hand not recorded in the initialization process is recognized in the monitoring area, a warning signal is output or quick lowering of the saw blade is performed in order to avoid a dangerous situation for this hand which is not made safe by the protection apparatus.

It is further preferred if the protection apparatus comprises an optical signal apparatus which is designed to emit a first signal when the protection apparatus is ready for operation and/or a hand has been recognized which does not represent a dangerous situation, and to emit a second signal when a hand has been recognized in an anticipatory dangerous situation which, if the hand is moved further, would develop into a dangerous situation within a period of time of less than one second, in particular less than half a second.

This development is based on the insight that an essential prerequisite for the practicality of a protection apparatus is that the user can rely on its functional capability and its current monitoring function in this respect, and that this functional capability and monitoring function is discernible for the user or that it is discernible for the user if the protection apparatus is not carrying out these functions. For this purpose, a corresponding signal apparatus is provided which signals to the user an operational state or a state in which it has been recognized that no hand is in danger with a first type of signal, and signals with a second signal an advance warning stage which indicates that the recognition of body parts and the determination of dangerous situations are functionally active. The user consequently has the possibility of seeing that there is a malfunction in the protection apparatus. The signal apparatus can in particular be formed by light signals which are arranged on the guard of the circular saw. Further functions of such a signal apparatus can be to signal a rotating saw blade using a third type of signal.

According to a further preferred embodiment or a further independent aspect of the invention, it is provided that the protection apparatus is designed to determine the location of a hand, the speed of movement of a hand in the direction of a danger point, and the acceleration of a hand in the direction of the danger area by the hand being recorded by an image capture apparatus, being converted into a two-dimensional hand projection onto the workpiece support surface, and the location of the hand projection and the vector portion of the speed of movement and the acceleration of the hand projection in the direction of the danger point being determined, and it being determined from the projected location, the projected speed of movement, and the projected acceleration of the hand within what period of time the hand would reach the danger point, and quick lowering of the saw blade or a safety measure being carried out if the period of time is less than a predetermined advance warning time, wherein the advance warning time is preferably predetermined from a saw blade projection above the workpiece support surface and/or a saw blade diameter.

It should be understood for this embodiment that it can be used independently of a height actuator which is activated for both the height setting and the quick lowering or in conjunction with a height actuator activated in such a way. The embodiment is furthermore independent of the design of the machine tool and is generally suited for machine tools where there is a risk of injury.

The embodiment provides that it is determined, from the projection onto the workpiece support surface of a position, a speed of movement in the direction of a danger area, and an acceleration of a hand in the direction of a danger point, whether a dangerous situation exists or not. To do this, a two-dimensional projection of the hand onto the workpiece support surface is recorded by means of an image capture device and the image evaluation in terms of the dangerous situation is determined on the basis of this projection. Decisive here is the vector portion of the speed of movement and the acceleration of the hand projection in the direction of a danger point. This danger point can be situated, for example, at the point of intersection of the saw blade circumference with the workpiece support surface, at the location at which the saw blade is closest to the user, i.e., the location at which the teeth of the saw blade enter the workpiece support surface from above. Two or more danger points can also be calculated, for example also the rear point of intersection between the saw blade circumference and the workpiece support surface and possibly also a point of intersection between the saw blade circumference and the upper surface of a workpiece which is being cut by the saw blade. If it is determined that the period of time within which the hand reaches the danger point is less than a predetermined advance warning time, quick lowering of the saw blade is performed because in this case, in the case of further movement of the hand, it would otherwise no longer be possible for the saw blade to be lowered below the workpiece support surface in time before contact with the hand. The advance warning time can here be predetermined within the sense of a fixed value. The advance warning time can, however, also be predetermined in a variable fashion by relevant parameters for calculating an advance warning time being used for the period of time within which the saw blade is lowered to avoid the danger. These parameters can be, for example, the saw blade projection above the workpiece support surface and/or the saw blade diameter because a longer advance warning time is required in the case of a larger saw blade diameter or a larger saw blade projection than in the case of a smaller saw blade diameter or a smaller saw blade projection in order to still reliably lower the saw blade to avoid a cut injury. Further parameters can also (additionally or alternatively) be taken into account when calculating the advance warning time, for example the tangential angle between the saw blade circumference and the workpiece support surface at the point of intersection between the saw blade circumference and the workpiece support surface. The advance warning time is to be calculated as longer here when this tangential angle is large and as shorter when this tangential angle is smaller because a horizontal spacing between an approaching hand is created more quickly when the saw blade is lowered vertically in the case of a smaller tangential angle than in the case of a larger tangential angle.

Lastly, it is further preferred if the circular saw has an emergency switch-off actuating element which is connected by signals to the protection apparatus, wherein the protection apparatus is designed to perform quick lowering of the saw blade when the emergency switch-off actuating element is actuated and to shut down all drive elements of the circular saw once the quick lowering is complete.

An emergency switch-off actuating element is in principle provided on a machine tool such as a circular saw and is also routinely stipulated in health and safety regulations in many countries. It is intended here that the emergency switch-off actuating element ensures the shutdown of all the structural elements of the circular saw which can be a risk to the user and is accordingly switched to interrupt the main power supply of the circular saw. However, a possible dangerous situation can in fact often be prevented by interrupting the main power supply only with a time delay, for example if the saw blade is still running down from a quick speed of rotation over a relatively long period of time after the drive motor has been shut down. It is therefore preferred to connect the actuation of the emergency switch-off actuating element to quick lowering of the saw blade which requires a corresponding energy supply to the actuators needed for this still for a short period of time after actuation of the emergency switch-off actuating element. According to the development, it is therefore provided not to shut down the whole circular saw immediately using the emergency switch-off actuating element, as a result of which the quick lowering could no longer be carried out, and instead to perform this shutdown only after the saw blade has been quickly lowered and consequently to produce a particularly safe state of the circular saw within a particularly short period of time.

It is fundamentally to be understood that the circular saw according to the invention can be configured in particular as a panel saw for which the safety system according to the invention is particularly well suited because of the quick machining cycles, the large saw blade diameters and saw blade projections, and the high saw blade speeds. The protection apparatus according to the invention is, however, furthermore also suited to other machine tools where there is potential danger. It can thus be used, for example, on plunge, table, or mitre saws which are often used portably in the building industry on construction sites and in which the protection apparatus according to the invention can advantageously be used because of the environmental conditions. Use of the protection apparatus on processing machines in the food-processing industry is also possible, for example on band saws. A dangerous situation for the operator can here be recognized with the aid of the protection apparatus according to the invention and, for example, a quick stop of the saw band generated as a protective measure.

### BRIEF DESCRIPTION OF THE DRAWINGS

Preferred embodiments of the invention are explained with the aid of the attached Figures, in which:

FIG. 1 shows a perspective view of a panel saw according to the invention, obliquely from the front and above;

FIG. 2 shows a plan view of the workpiece support surface of the panel saw with a schematically indicated monitoring area and danger areas;

FIG. 3 shows a side view in section with the lines of sight of the monitoring apparatus illustrated;

FIG. 4 shows a front view of the panel saw with the lines of sight of the monitoring apparatus illustrated;

FIG. 5 shows a perspective view of the sawing unit of the panel saw in a tilted position, obliquely from the right, behind, and above;

FIG. 6 shows a perspective view of the sawing unit of the panel saw in an untilted position, obliquely from the left, behind, and above;

FIG. 7 shows a perspective part view of the sawing unit of the panel saw in the blade-change position, obliquely from the right, front, and above;

FIG. 8 shows a schematic side illustration of the panel saw with a large and small saw blade and a small saw blade projection;

FIG. 9 shows a schematic side illustration of the panel saw with a large saw blade and a large saw blade projection; and

FIG. 10 shows a schematic plan view of the workpiece support surface with a danger point included therein and a hand approaching the saw blade.

### DETAILED DESCRIPTION OF THE EMBODIMENTS

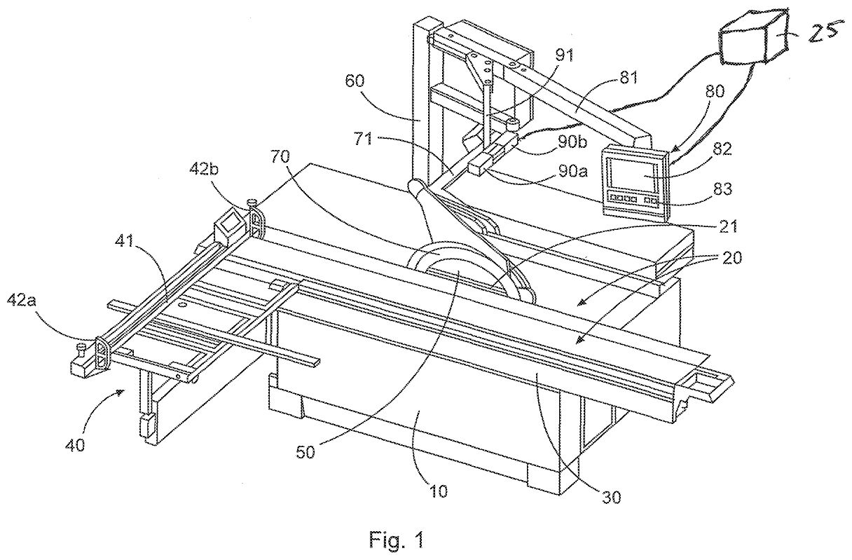

The fundamental structure of a panel saw is explained with reference first to FIG. 1. The panel saw comprises a machine base body 10 on the upper side of which a workpiece support surface 20 is arranged. A carriage 30 for a translational horizontal movement is mounted on the machine base body. The upper surface of the carriage 30 is a constituent part of and flush with the workpiece support surface 20. A crosscut table 40, which can be moved in translation together with the carriage 30, is fastened to the carriage 30. Situated on the crosscut table 40 is a crosscut fence 41 which is tiltable and repositionable and is mounted longitudinally displaceably on the length stops 42a, 42b in order consequently to be able to set the cut angles and cutting lengths of a workpiece resting against it.

A saw slot 21, through which a saw blade 50 extends vertically, is arranged in the workpiece support surface 20. The saw blade 50 is mounted so that it can rotate about a saw blade axis SBA which is arranged below the workpiece support surface 20 inside the machine body 10.

A vertical post 60, to which a guard 70 is fastened via a first cantilever arm 71, is fastened to the machine body 10. The guard 70 encloses the saw blade 50 from above and the circumferential angle of the enclosure can be altered by adjusting the height of the guard 70. The guard 70 can furthermore follow a tilting of the saw blade 50 about a horizontal axis lying in the sawing direction by being shifted laterally. The guard 70 serves, on the one hand, to cover the saw blade 50 for the purpose of safety when working and, on the other hand, the sawdust produced during the cutting is sucked away via the guard 70 by means of a suitable suction device.

A user interface 80 is arranged on a second cantilever arm 81. The user interface 80 comprises a display 82 for displaying machine parameters and information on the saw cut and the arrangement of workpieces on the workpiece support surface 20. Various operating units are furthermore arranged at the operator interface 80 comprising, inter alia, an emergency switch-off button 83.

A monitoring device with two cameras 90a, 90b interconnected with a control device 25 is arranged on a third cantilever arm 91. The monitoring device is arranged above the saw blade 50 such that the cameras 90a, 90b view the area around the saw blade 50 with a viewing direction onto the workpiece support surface 20 which is directed vertically downward.

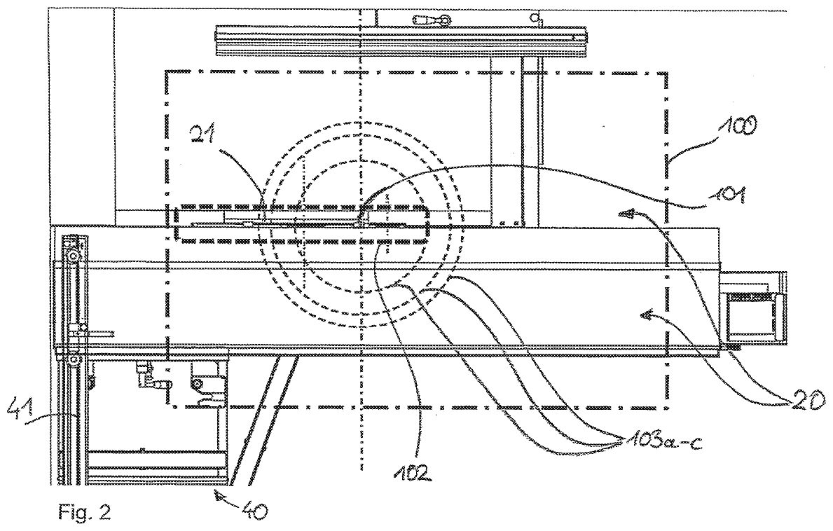

FIG. 2 shows the monitoring area 100 recorded by the cameras 90a, 90b and monitored by the control device 25. The monitoring area 100 is rectangular and encloses the danger point 101 situated centrally therein. The danger point 101 is the point of intersection between the outer circumference of the saw blade 50 and the workpiece support surface 20 on the front saw blade edge which faces the workpiece before the cut and at which the saw teeth arranged at the saw blade circumference normally enter the workpiece support surface 20 from above. The monitoring area 100 comprises a stationary part, arranged on the machine body 10, of the workpiece support surface 20, and a movable part, arranged on the carriage 30, of the workpiece support surface 20.

A likewise rectangular surface section, delineated section 102, around the circular saw blade 50 delineates an area, covered by the guard 70, of the workpiece support surface 20 from the monitoring area. Monitoring in delineated section 102 is not possible because it is shielded by the guard 70. If body parts which are recorded in the monitoring area 100 enter this delineated section 102, this represents a dangerous situation and results in appropriate measures explained below.

A danger area 103a-c, which is situated completely inside the monitoring area apart from the delineated section 102, is arranged as a circle around the danger point 101. The size of the danger area can be varied, as symbolized in FIG. 2 by three alternative circles 103a-c illustrated in dashed lines, one of which delimits the danger area. The size of the danger area, in the present example the diameter of the circle delimiting the danger area, is specified on the basis of the operating parameters and the movement parameters of the body part and is dependent on both adjustable machine parameters such as the circular saw blade diameter or projection and on constantly changing operating and usage parameters such as the position and type of movement of the operator's hand, as explained in detail below.

It is fundamentally to be understood that other geometries can also be used as alternatives to the illustrated rectangular geometry of the monitoring area and the circular geometry of the danger area, for example areas defined by curved lines, by an oval, or areas delimited in the form of a figure eight, or the like.

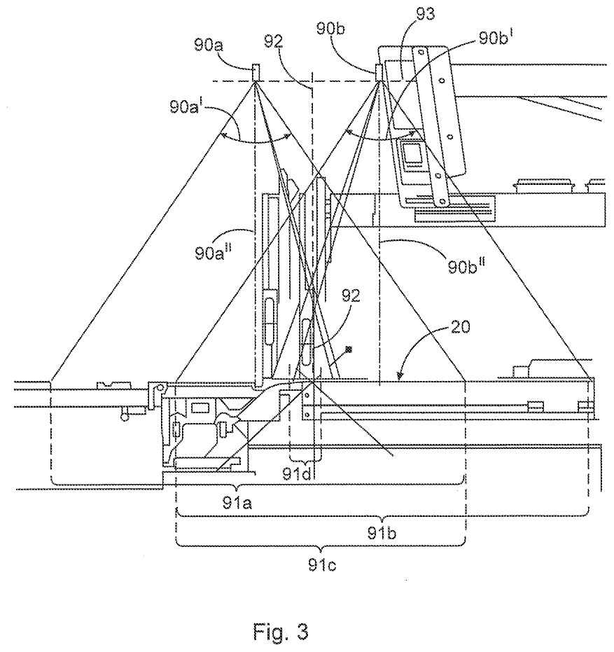

FIG. 3 illustrates a side view of the viewing angle of the two cameras 90a, 90b. As can be seen, each of the two cameras 90a, 90b has a viewing angle 90a′, 90b′ with a vertical viewing direction onto the workpiece support surface 20 and consequently capture a camera capture area 91a, 91b. The camera capture areas 91a, 91b overlap in a central area 91c which contains all of the saw blade 50 and the saw blade slot 21. Because they are covered by the guard 70, inside this overlap area 91c, two areas to the left and right of the guard 70 can be monitored by just one of the cameras 90a, 90b and a small area 91d in between by neither of the cameras 90a, 90b. This area 91d represents a delineated section from the monitoring area which corresponds to the delineated area 102 of FIG. 2 and is subject to a separate monitoring method.

The cameras 90a, 90b are arranged, to the left and right of a saw blade plane 92 within which the saw blade 50 lies in the case of a horizontally situated saw blade axis, on a camera axis 93 which is situated perpendicular to this saw blade plane 92. As can be seen, the line of sight of the front camera 90a is situated closer to the saw blade plane 92 in the cutting direction than the line of sight of the rear camera 90b such that an asymmetrical arrangement of the two cameras 90a, 90b with reference to the saw blade plane 92 results.

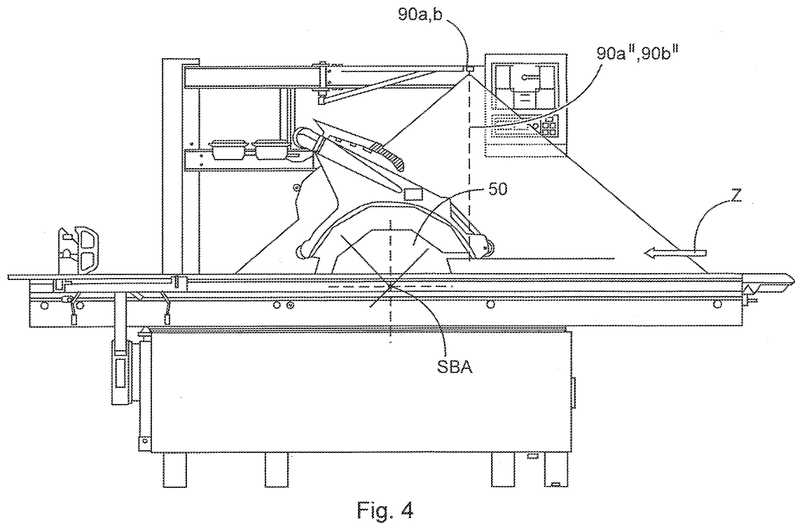

FIG. 4 shows the field of view of the cameras 90a, 90b in a front view. As can be seen, the cameras 90a, 90b look downward on in each case a vertical line of sight 90a″, 90b″. The camera axis 93 on which the two cameras 90a, 90b are arranged is here arranged at a height approximately perpendicularly above a danger point on a medium-sized saw blade, with a horizontal spacing of approximately 150 mm in front of the saw blade axis SBA. In the view according to FIG. 4, workpieces are fed from the right-hand side and guided in a feed direction Z to the left through the saw blade 50 and cut. The vertical lines of sight 90a″, 90b″ are therefore offset to the front relative to the saw blade axis SBA counter to the feed direction Z, and the cameras are consequently shifted forward relative to the saw blade axis SBA (to the right in FIG. 4) and therefore monitor a larger area in front of the saw blade than behind the saw blade.

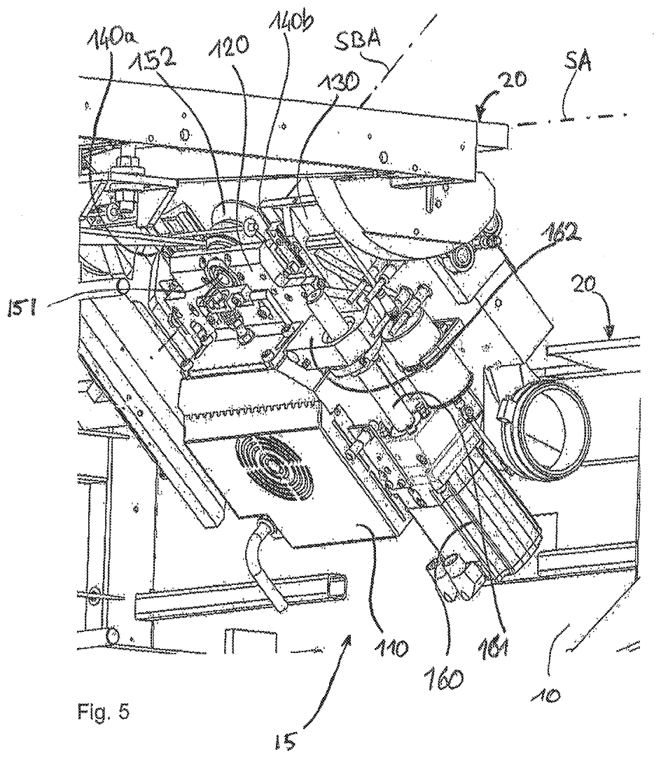

FIG. 5 shows a perspective view of the sawing unit of the panel saw according to the invention. The sawing unit 15 is fundamentally arranged below the workpiece support surface 20 inside the machine body 10. The whole sawing unit 15 can be tilted about a horizontal virtual tilt axis SA extending in the sawing direction and which runs at the level of the workpiece support surface 20 through the saw blade slot 21 in the longitudinal direction. It is consequently possible to tilt the saw blade axis SBA and hence the saw blade 50 such that the passage of the saw blade 50 through the saw blade slot 21 remains unchanged in each tilted position. FIG. 5 shows the sawing unit 15 in a tilted position in which the saw blade axis SBA thus does not run parallel to the workpiece support surface 20 and consequently horizontally. The sawing unit 15 of the panel saw according to the invention can in principle be configured for tilting to one side or both sides. In the case of one-sided tilting, the sawing unit 15 can be tilted about the tilt axis SA only in one direction, starting from the orientation with a horizontally situated saw blade axis SBA. In the case of two-sided tiltability, the sawing unit 15 can be tilted about the tilt axis SA in both directions, starting from the position with a horizontal saw blade axis SBA.

The sawing unit 15 furthermore comprises a saw blade drive motor 110 which has an output shaft to which a lower V-ribbed belt pulley is fastened by means of which an upper V-ribbed belt pulley fastened to a saw blade shaft 151 is driven via a V-ribbed belt. This saw blade shaft is mounted in a saw blade bearing unit 120 so that it can rotate about the saw blade axis SBA. A saw blade flange 152, to which the saw blade 50 is fastened, is furthermore arranged on the saw blade shaft 151.

The whole unit consisting of the saw blade drive motor 110, the saw blade bearing unit 120, and the saw blade flange 152 is mounted vertically displaceably by means of a linear bearing which comprises two linear guide rails 140a, 140b fastened to a sawing unit frame 130 and linear guide shoes guided thereon. The projection height by which the saw blade 50 projects from the saw blade slot 21 above the workpiece support surface 20 can be set by virtue of this vertical displaceability. This setting can be set in each tilted position of the sawing unit because the linear guide is fastened on the sawing unit frame 130 which is tilted together with the sawing unit.

A servo motor 160 which drives a spindle drive 161 is furthermore fastened to the sawing unit frame 130. The servo motor 160 is immovably fastened to the sawing unit frame 130. A spindle plate 162, which is moved up and down by rotation of a spindle drive 161 along the longitudinal axis of the spindle drive 161, is guided on a spindle drive 161 driven by the servo motor 160. The saw blade bearing unit 120 and the saw blade drive motor 110 are connected to the spindle plate 162. The saw blade bearing unit 120 can therefore be displaced vertically along the linear guide rails 140a, 140b with the saw blade drive motor 110 by driving the spindle drive 161.

The servo motor 160 is activated, on the one hand, for the purpose of such a displacement in order to set a saw blade projection desired by the user for a sawing procedure. This saw blade projection is typically chosen such that is chosen to be approximately a tooth height of the saw blade 50 greater than the thickness of the workpiece to be cut when a separating cut is to be made. If, in contrast, a groove is to be cut, the saw blade projection is set to be the same as the groove depth. For the purpose of setting an exact saw blade projection, the servo motor 160 is activated at a slow setting speed which can be, for example, approximately 5 cm/s.

The servo motor 160 can furthermore be activated for quick lowering. In this case, the servo motor 160 serves to lower the saw blade 50 in the shortest possible time in order thereby to avoid a dangerous situation produced by a body part approaching the saw blade 50 and to prevent the approaching body part from being injured by the saw blade 50. In this case, the servo motor 160 is activated with a very high, in particular the maximum permissible drive power and consequently rapidly accelerates the saw blade 50 downward. In the case of such quick lowering, the servo motor 160 achieves a speed of movement of the saw blade bearing unit 120 of more than 0.5 m/s, in particular more than 1 m/s, and the servo motor 160 and the spindle drive 161 are preferably designed such that a lowering speed of more than 2 m/s or more than 4 m/s can be generated. As a result, it is ensured that the saw blade 50 can be lowered at a sufficiently high speed to reliably prevent contact of the body part with the saw blade 50 even when the body part approaches the saw blade 50 at high speed.

During quick lowering, the servo motor 160 is here activated such that it first generates a maximum acceleration, directed downward, of the saw blade bearing unit 120 with the saw blade 50 fastened thereto. After a certain amount of travel and before the end stop of the spindle drive 161 is reached, the servo motor 160 is decelerated again in order thereby to brake the rapid vertical downward movement of the saw blade 50 and the saw blade bearing unit 120. This deceleration is effected by a negative acceleration, i.e., a braking acceleration, which is great enough to decelerate the vertical downward movement of the saw blade bearing unit 120 with the saw blade 50 to preferably zero but at least to a low speed until the stop of the spindle drive 161 is reached. A hard impact at the end of the displacement travel is avoided as a result.

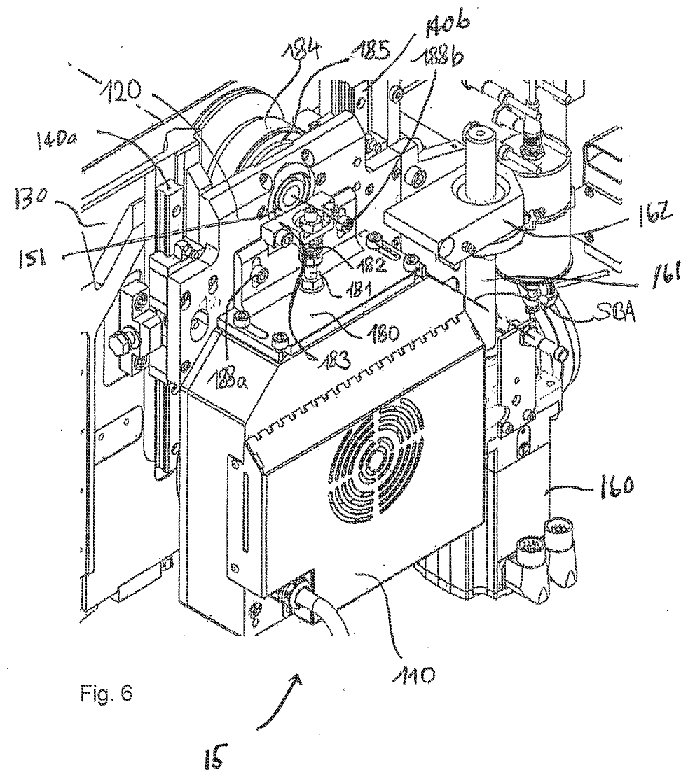

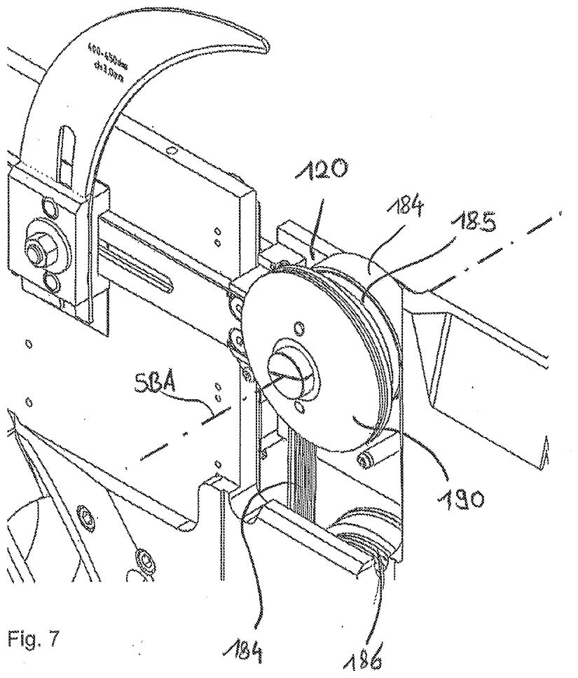

FIG. 6 shows the sawing unit 15 in a perspective side view from the left and FIG. 7 shows an upper part of the sawing unit in a perspective view from the front, right, and above. A lower support plate 180, on which a stack of compression springs 182 consisting of a plurality of plate springs is supported around a vertically upward extending threaded bolt 181, is fastened on an upper housing wall section of the saw blade drive motor 110. The stack of compression springs 182 supports with compression spring force an upper support plate 183 which is fastened to the saw blade bearing unit 120. A tension is thus applied by the stack of compression springs 182 to a V-ribbed belt 184 which runs between an upper belt pulley 185 mounted in the saw blade bearing unit 120 and a lower belt pulley 186 fastened on the output shaft of the saw blade drive motor 110 (see FIG. 7). The V-ribbed belt 184 is pretensioned with high tension by loosening two screws 188a, 188b placed in slots. This pretensioning can be fixed by tightening the two screws 188a, 188b and remains unchanged for a long operating period because virtually no elongation of the V-ribbed belt 184 takes place.

FIG. 7 shows the saw blade bearing unit 120 in a blade-change position. In this blade-change position, the sawing unit is lowered with the aid of the servo motor 160 and the spindle drive 161 so far that a saw blade 50 with the maximum permissible diameter can be removed from the saw blade holder 190 mounted in the saw blade bearing unit 120 so that it can rotate about the saw blade axis SBA or be placed thereon and clamped therein. The blade-change position is activated by the servo motor 160 in response to a corresponding operator input and then locked by means of a locking brake (not visible) inside the servo motor 160 and consequently reliably maintained. This avoids the risk of injury to the operator when changing saw blades.

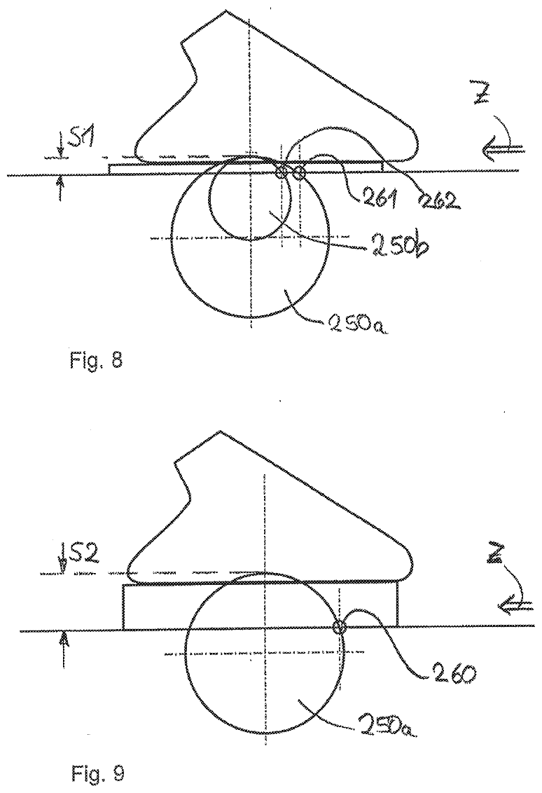

FIG. 8 shows a schematic illustration of two differently sized saw blades 250a, 250b with a small saw blade projection S1. Illustrated here is an orientation in which the workpiece is guided during a saw cut from right to left in a feed direction Z.

FIG. 9 shows a schematic illustration of the large saw blade 250a with a large saw blade projection S2.

As can be seen in FIGS. 8 and 9, different positions of the danger point, which is defined as the point of intersection of the saw blade circumference with the workpiece support surface at the front side of the saw blade 50, result for these different saw blade sizes and saw blade projections. The furthest forward danger point 260 results for a large saw blade 250a with a large saw blade projection S2 (FIG. 9). If the large saw blade 250a is lowered and set to a smaller saw blade projection S1, a second danger point 261, situated behind this danger point 260 in the feed direction of the workpiece, results. If a small saw blade 250b is used instead of the large saw blade 250a, the danger point 262 of this small saw blade 250b, with the same (small) saw blade projection S1, is in turn situated shifted further in the direction of the workpiece feed direction Z.

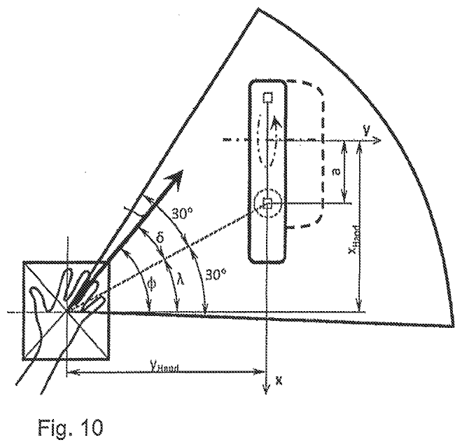

FIG. 10 shows a schematic illustration of the calculation of the position and movement of a user's hand. The calculation is made by projecting the hand onto the workpiece support surface 20 and with reference to an XY coordinate system which uses as a center point a point situated vertically above the saw blade axis in the workpiece support surface 20 and situated within the cutting plane. The Y-axis here runs parallel to the workpiece support surface and within the plane in which the saw blade axis is situated in any titled position. The X-axis corresponds to the line of intersection between the workpiece support surface and the cutting plane.

In this case, the angle φHand, which is spanned between the Y-axis and the direction of movement of the hand, is calculated as

$${φ}_{Hand} = arctan \frac{{y}_{2} + {y}_{1}}{{x}_{2} + {x}_{1}}$$

This angle φ_{Hand} defines the direction of movement of the hand.

The speed of movement of the hand v_{Hand} is calculated as

$${v}_{Hand} = \frac{\sqrt{{( {y}_{2} + {y}_{1} )}^{2} + {( {x}_{2} + {x}_{1} )}^{2}}}{{t}_{2} - {t}_{1}}$$

If the spacing a between the main danger point and the projection of the axis of rotation into the workpiece support surface 20 is determined as

$$a = \sqrt{{( \frac{d}{2} )}^{2} - {( \frac{d}{2} - h )}^{2}}$$

where
   d corresponds to the diameter of the saw blade 50, and
   h corresponds to the saw blade projection,
the angle λ, which describes the direction of the shortest spacing between the middle of the hand and the main danger point, can be calculated by

$$λ = arctan \frac{{x}_{Hand} - a}{{y}_{Hand}}$$

It can then be identified from these calculation data whether an injury would occur to the hand on the saw blade 50 within such a period of time which is less than the advance warning time required to lower the saw blade 50 in time to avoid such an injury by it being determined whether the calculated speed of the hand v_{Hand} is greater than or equal to a maximum speed vₘₐₓ which can be predetermined as, for example, 2 m/s, and whether furthermore the size of the angle δ is less than or equal to a predetermined tolerance angle which can, for example, be 30°,

$$( {v}_{Hand} \geq {v}_{max} ) ∧ ( \vert δ \vert \leq 30 ° )$$

where the angle δ is calculated by φHand minus λ:

$$δ = {ϕ}_{H a n d} - λ$$

If both conditions are met, quick lowering must be performed and the servo motor 160 activated accordingly. If one of the two conditions is not met or if neither condition is met, there is no dangerous situation, i.e., the hand will not reach the danger point within the advance warning time either because it is moving too slowly or because its movement path passes the danger point with a sufficient spacing.

1.-25. (canceled)

26. A circular saw comprising:
a support surface for a workpiece, the support surface further comprising a saw blade slot;
a main drive motor arranged below the support surface for driving a saw blade disposed in the blade slot in rotational movement;
a saw blade holder connected to the main drive motor for the purpose of transmitting the rotational movement and comprising a saw blade bearing unit and a saw blade flange mounted so that the saw blade flange can be rotated about a saw blade axis by the saw blade bearing unit and so that the saw blade flange can be connected to the saw blade so that the saw blade is fixed in torsion;
a height-adjustment apparatus comprising a height actuator and a transmission element coupled to the saw blade holder for adjusting the spacing between the saw blade holder and the support surface;
an electronic interface for the input of a saw blade projection defining the spacing between the saw blade holder and the support surface;
a control device in signal communication with the electronic interface and the height actuator, the control device adapted to activate the height actuator such that a saw blade projection input via the user interface is set by means of the height actuator; and
a protection apparatus for quickly lowering the saw blade in a dangerous situation having a monitoring apparatus for detecting the dangerous situation;
wherein the protection apparatus is in signal communication with the monitoring apparatus and the height actuator and is adapted to activate the height actuator for quickly lowering the saw blade holder when the dangerous situation is detected by the monitoring apparatus.

27. The circular saw according to claim 26, wherein the height actuator is an electric servo motor.

28. The circular saw according to claim 26, wherein the protection apparatus or the control apparatus is adapted to:
in a first operating mode, activate the height actuator for setting the saw blade to an initial saw blade projection;
in a second operating mode, activate the height actuator for quick lowering of the saw blade; and
in a third operating mode, activate the height actuator for restoring the saw blade to the initial saw blade projection after quick lowering.

29. The circular saw according to claim 28, wherein the protection apparatus or the control apparatus is further adapted to:
in a fourth operating mode, activate the height actuator for setting a blade-change position;
wherein the circular saw further comprises a brake apparatus for frictional or positive immobilization of the saw blade in the blade-change position, and the protection apparatus or the control apparatus is further adapted to activate the brake apparatus, after the blade-change position has been set by the height actuator, to immobilize the saw blade in the blade-change position.

30. The circular saw according to claim 26, wherein the saw blade holder and the saw slot are adapted to receive saw blades with a diameter of more than 350 mm, and the protection apparatus is adapted to activate the height actuator and to displace the saw blade, in the case of quick lowering, from a position with an initial projection above the support surface into a lowered position with a final projection of the saw blade above the support surface that is smaller than the initial projection.

31. The circular saw according to claim 26, wherein the protection apparatus is adapted to activate the height actuator for quick lowering;
wherein in an acceleration phase the saw blade holder is accelerated downward to a lowering speed; and
wherein thereafter to activate the protection apparatus in a braking phase in which the saw blade holder is braked from the lowering speed.

32. The circular saw according to claim 31, wherein the protection apparatus is adapted to activate the height actuator for a transition from the acceleration phase into the braking phase as soon as:
a deceleration calculated from a calculated braking distance and the current lowering speed of the saw blade exceeds a predetermined maximum deceleration, wherein the calculated braking distance is calculated by subtracting the current depth of descent from a predetermined maximum depth of descent of the saw blade;
a calculated braking distance is less than 50 mm, wherein the calculated braking distance is calculated by subtracting the current depth of descent from a predetermined maximum depth of descent of the saw blade; and/or
the saw blade axis is below the support surface by a spacing which is greater than or equal to half the diameter of the saw blade when the height-adjustment apparatus has an adjustment travel which is at least 50 mm greater than half the saw blade diameter.

33. The circular saw according to claim 26, wherein the protection apparatus is adapted to receive a saw blade diameter and the saw blade projection via an input interface and to specify from the saw blade diameter and the saw blade projection a danger area, around the saw blade, situated inside a monitoring area monitored by the protection apparatus;
wherein the danger area is specified by the control device as larger for a large saw blade diameter than for a small saw blade diameter and/or the danger area is specified by the control device as larger for a large saw blade projection than for a small saw blade projection; and
wherein the protection apparatus is adapted to determine, with the aid of the location and the movement of a hand of a user which is detected by the protection apparatus in the monitoring area, within what period of time the hand would enter the danger area, and to perform quick lowering of the saw blade when the determined period of time is less than a predetermined advance warning time.

34. The circular saw according to claim 26, wherein:
the saw blade holder is operably coupled to the main drive motor by a multiple ribbed belt which is tensioned to a belt tension by of a self-adjusting belt tensioning device;
the main drive motor is a three-phase AC motor and the control device or the protection apparatus is adapted to simultaneously brake the main drive motor for the purpose of quick lowering by the injection of direct current and, in an initial braking phase, feed in braking direct current at a predetermined level of current and reduce the braking direct current after a predetermined braking time; and
the belt tensioning device is adapted to set the belt tension at between 90% and 100% of an upper limit of a predetermined belt tensioning range.

35. The circular saw according to claim 26, wherein the protection apparatus comprises a monitoring apparatus with an image capture apparatus and an image evaluation device, and the image evaluation device is in signal communication with the height actuator to activate the height actuator for quick lowering of the saw blade holder when a dangerous situation is identified.

36. A circular saw comprising:
a support surface for a workpiece, the support surface having a saw blade slot;
a main drive motor arranged below the support surface for driving a saw blade in rotational movement;
a saw blade holder connected to the main drive motor for the purpose of transmitting the rotational movement and comprising a saw blade bearing unit and a saw blade flange which is mounted so that the saw blade flange can be rotated about a saw blade axis by the saw blade bearing unit and is adapted to be connected to the saw blade so that the saw blade is fixed in torsion; and
a protection apparatus for quickly lowering the saw blade in a dangerous situation, the protection apparatus comprising a monitoring apparatus for detecting a dangerous situation and a height-adjustment apparatus, with a height actuator and a transmission element coupled to the saw blade holder, which is adapted to lower the saw blade holder when a dangerous situation is identified by the monitoring apparatus;
wherein the monitoring apparatus comprises an image capture apparatus and an image evaluation device and the image evaluation device is in signal communication with the height actuator to activate the height actuator when a dangerous situation is identified for quickly lowering the saw blade holder.

37. The circular saw according to claim 36, wherein the image capture device comprises a first camera and a second camera and the image evaluation device comprises a first and a second image evaluation unit; and
the first camera and the second camera are arranged at a spacing from each other above a support surface and each of the first camera and the second camera have a recording direction which is oriented in the direction of the support surface;
wherein:
the first camera is in signal communication with the first image evaluation unit, which is adapted to receive image data from the first camera and process the data by a first piece of evaluation software to identify whether a dangerous situation exists; and
the second camera is in signal communication with the second image evaluation unit which is adapted to receive image data from the second camera and process the data by a second piece of evaluation software to identify whether a dangerous situation exists; and
wherein the first piece of evaluation software is different from the second piece of evaluation software and/or the first image evaluation unit is different from the second image evaluation unit.

38. The circular saw according to claim 37, wherein:
the first piece of evaluation software has a first operating system running on the first image evaluation unit and a first image evaluation algorithm running on the first image evaluation unit;
the second piece of evaluation software has a second operating system running on the second image evaluation unit and a second image evaluation algorithm running on the second image evaluation unit; and
wherein:
the first and the second image evaluation unit are different from each other;
the first and the second operating system are the same each other and the first and the second image evaluation algorithm are different from each other;
the first and the second operating system are different from each other and the first and the second image evaluation algorithm are the same as each other; or
the first and the second operating system are different from each other and the first and the second image evaluation algorithm are different from each other.

39. The circular saw according to claim 37, wherein the image evaluation device is adapted to evaluate image data from a monitoring area and image data from a danger area, wherein the danger area is arranged inside the monitoring area and comprises a danger point at which a user could be injured on the saw blade, and wherein a surface unit in the danger area is captured by the first or second camera with more pixels than a surface unit of the same size in the monitoring area.

40. The circular saw according to claim 37, wherein the image evaluation device is adapted to receive operating parameters of the circular saw and to alter the size of the danger area depending on the operating parameters of the circular saw.

41. The circular saw according to claim 40, wherein the operating parameters include a diameter of the saw blade and a saw blade projection of the saw blade above the support surface; and
wherein the image evaluation device is adapted to specify, from the saw blade diameter and the saw blade projection, an entry point and/or an exit point of the saw teeth arranged at the circumference of the saw blade into or from the workpiece support surface as danger points and to place the danger area around one or both danger points as a predetermined geometry.

42. The circular saw according to claim 40, wherein the operating parameters include a diameter of the saw blade and a saw blade projection of the saw blade above the support surface and the image evaluation device is adapted to:
define the danger area as larger in the case of a large saw blade diameter than in the case of a small saw blade diameter;
define the danger area as larger in the case of a large saw blade projection than in the case of a small saw blade projection; and/or
specify, from the saw blade diameter and the saw blade projection, a tangential angle between the tangent at the circumference of the saw blade in the support surface to the support surface and to define the danger area as larger in the case of a large tangential angle than in the case of a small tangential angle.

43. The circular saw according to claim 35, further comprising a guard arranged above the support surface and which at least partially encloses the saw blade and is height-adjustable;
wherein the image evaluation device is adapted to identify a dangerous situation if a user's body part recognized by the image capture device is arranged such that the guard is located between a portion of body part and the image capture device or if the guard is located in an optical path of a first camera or a second camera of the image capture device and a portion of the body part.

44. The circular saw according to claim 35, further comprising a guard arranged above the support surface and which at least partially encloses the saw blade and is height-adjustable, wherein:
the guard can be moved away from a position above the saw blade slot into a position next to the saw blade slot; and
the image evaluation device is adapted to specify, in the case of a guard moved away from the position above the saw blade slot, an outline or part of an outline of a virtual guard, and to identify a dangerous situation when a user's body part recognized by the image capture device is arranged such that the outline or part of the outline is located between a portion of the body part and the image capture device or when the outline or part of the outline is located in an optical path of a first camera or a second camera of the image capture device and a portion of the body part.

45. The circular saw according to claim 44, wherein the image evaluation unit adapted to determine a position of the guard or the circular saw comprises a position sensor which recognizes a position of the guard.

46. The circular saw according to claim 35, further comprising:
a guard arranged above the support surface and which at least partially encloses the saw blade and is height-adjustable; and
a guard height sensor adapted to determine the height of the guard above the workpiece support surface;
wherein the control device is adapted to form a height-comparison value on the basis of a comparison between the guard height above the support surface determined by the guard height sensor and the saw blade projection, and to output a warning signal if the height-comparison value exceeds a predetermined height-comparison threshold value.

47. The circular saw according to claim 35, wherein:
the image capture device comprises a first camera and a second camera;
the first camera has a first image capture surface with a first area centroid which is arranged on a first side of the saw blade slot in the support surface;
the second camera has a second image capture surface with a second area centroid which is arranged on a second side, opposite the first side of the saw blade slot in the support surface; and
the spacing between the first area centroid and the saw blade slot is less than the spacing between the second area centroid and the saw blade slot.

48. The circular saw according to claim 47, wherein the first and the second image capture surface overlap in an overlap area and the overlap area covers the saw blade slot and has a surface size which is more than 50% of the surface size of the first image capture surface.

49. The circular saw according to claim 26, wherein the protection apparatus is adapted to perform an initialization process in which the hands of each user of the circular saw are recorded by the monitoring apparatus, and wherein:
the initialization process must be performed every day at least once before the first sawing procedure in order to carry out a sawing procedure; and
the protection apparatus performs quick lowering of the saw blade if the monitoring apparatus recognizes a hand in the monitoring area which was not recorded in a preceding initialization process.

50. The circular saw according to claim 26, wherein the protection apparatus comprises an optical signal apparatus adapted to:
emit a first signal when the protection apparatus is ready for operation and/or a hand has been recognized which does not represent a dangerous situation; and
to emit a second signal when a hand has been recognized in an anticipatory dangerous situation which, if the hand is moved further, would develop into a dangerous situation within a period of time of less than one second.

51. The circular saw according to claim 26, wherein the protection apparatus is adapted to:
determine the location of a hand, the speed of movement of a hand in the direction of a danger point, and the acceleration of a hand in the direction of the danger area by the hand being recorded by an image capture apparatus, being converted into a two-dimensional hand projection onto the support surface, and the location of the hand projection and the vector portion of the speed of movement and the acceleration of the hand projection in the direction of the danger point being determined;
it being determined from the location, the speed of movement, and the acceleration of the hand within what period of time the hand would reach the danger point; and
quick lowering of the saw blade being carried out if the period of time is below a predetermined advance warning time;
wherein the advance warning time is predetermined from a saw blade projection above the support surface and/or a saw blade diameter.

52. The circular saw according to claim 26, wherein an emergency switch-off actuating element is in signal communication with the protection apparatus; and
wherein the protection apparatus is adapted to perform quick lowering of the saw blade when the emergency switch-off actuating element is actuated and to shut down all drive elements of the circular saw once the quick lowering is complete.

53. A circular saw comprising:
a support surface for a workpiece, the support surface further comprising a saw blade slot;
a main drive motor arranged below the support surface for driving a saw blade disposed in the blade slot in rotational movement;
a saw blade holder operably coupled to the main drive motor for the transmitting the rotational movement and comprising a saw blade bearing unit and a saw blade flange, wherein the saw blade flange can be rotated about a saw blade axis by the saw blade bearing unit and so that the saw blade flange can be connected to the saw blade such that the saw blade is fixed in torsion;
a height-adjustment apparatus comprising a height actuator and a transmission element coupled to the saw blade holder for adjusting the spacing between the saw blade holder and the support surface;
an electronic interface for the input of a saw blade projection defining the spacing between the saw blade holder and the support surface;
a control device in signal communication with the electronic interface and the height actuator, the control device adapted to activate the height actuator such that a saw blade projection input via the user interface is set by means of the height actuator; and
a protection apparatus for quickly lowering the saw blade in response to a set of predetermined criteria defining a dangerous situation, the protection apparatus having a monitoring apparatus for detecting the dangerous situation;
wherein the protection apparatus is in signal communication with the monitoring apparatus and the height actuator and is adapted to activate the height actuator for quickly lowering the saw blade holder when the dangerous situation is detected by the monitoring apparatus.
